(19) United States
(12) Patent Application Publication
(10) Pub. No.: US 2025/0296510 A1
(43) Pub. Date: Sep. 25, 2025

(54) COLLAPSIBLE, STOWABLE, RIGID STAIR STRUCTURES AND METHODS OF USING SAME

(71) Applicant: Walter P. DEMONTE, MAIDSTONE (CA)

(72) Inventor: Walter P. DEMONTE, MAIDSTONE (CA)

(21) Appl. No.: 19/082,487

(22) Filed: Mar. 18, 2025

Related U.S. Application Data
(60) Provisional application No. 63/567,088, filed on Mar. 19, 2024.

(51) Int. Cl. B60R 3/02

(52) U.S. Cl. CPC B60R 3/02

(57) ABSTRACT

A stowable, rigid stair structure includes a pair of support rails configured to be fixed beneath a support surface and spaced apart from each other, a rigid stair unit including at least one step and side walls connected at lateral sides of the at least one step, and supporting projections extending continuously from the side walls of the rigid stair unit away from the at least one step and operatively, movably connected to the support rails to permit the rigid stair unit to be moved relative to the support rails between stowed and operative positions of the rigid stair unit. When the support rails are fixed to the at least one support surface, the rigid stair unit is fully supported in both the stowed and use positions thereof by the supporting projections operatively connected to the support rails and by the at least one support surface.

### CROSS-REFERENCE TO RELATED APPLICATIONS

This application claims priority from U.S. Provisional Patent Application No. 63/567,088, filed Mar. 19, 2024, the entire contents of which are incorporated herein by reference.

### BACKGROUND OF THE INVENTION

### 1. Field of the invention

The present invention relates to a compact, collapsible, stowable, rigid stair structure configured to be attached to and fully supported by a support surface, and which is robust, stable, easy to use and relatively lightweight. More particularly, the present invention relates to such a collapsible, compact, stowable, rigid stair structure which can be easily attached to any appropriate support surface, and may be easily used by substantially any size person to stably and safely step up relative to the support surface. The structure is not complex or intrusive, easy to install, easily and quickly moved between stored and use positions thereof, and is also relatively lightweight and inexpensive.

### 2. Description of the Background Art

There are many known stowable type ladder or stair devices which may be connected to or associated with a flat surface, including flat surfaces of trucks, trailers and other vehicles, and which are configured to be moved between use positions and stowed positions, and some of which are also collapsible and/or relatively compact in size for being disposed in the stowed positions thereof. Examples of some of the known stowable type ladder or stair devices include those described in U.S. Pat. Nos. 4,860,854, 5,687,813, 5,941,342, 6,003,633, 7,516,997, US Published Patent Application No. 2015/0076785 and CN Published application 113147604. The devices in U.S. Pat. Nos. 5,687,813, 5,941,342 and 7,516,997 may be attached to a rear portion of a vehicle, such as a pick-up tailgate or the rear end of a semi-tractor trailer, and may be selectively moved to a use position and a collapsed or partly collapsed storage position. The device in U.S. Pat. No. 6,003,633 includes a ladder member with rungs, may be selectively attached to a rub rail on a lateral side of a semi-tractor trailer, and may be selectively moved to a use position and a partly collapsed storage position. The devices in U.S. Pat. No. 4,860,854, US Published Patent Application No. 2015/0076785 and CN Published application 113147604 include slim, rigid ladder members with rungs, and which may be selectively moved between stowed and use positions by being slid into and out of supporting storage rails fixed to a support surface, which may be a vehicle surface, wherein the ladder members pivot relative to the storage rails when being moved between the storage and use positions. U.S. Pat. No. 7,516,997 also discloses ladder devices which include non-collapsible stair units with planar steps, each of which non-collapsible units includes rollers at one end thereof to facilitate movement between stowed and use positions thereof as the rollers permit the non-collapsible stair units to be rolled along supporting storage rails stably suspended from a support surface of a vehicle, and supporting brace member(s) and brackets used to secure the non-collapsible stair units to other surface(s) of the vehicle when in the use positions thereof.

Although the known stowable type ladder or stair devices are usable for their intended purposes, they all have drawbacks associated therewith, which have limited their use. For example, the stowable devices in each of U.S. Pat. Nos. 5,687,813, 5,941,342, 6,003,633 and 7,516,997 project from the vehicle surfaces they are attached to, even when in the stored positions thereof, whereby they may interfere with normal use of such surfaces and may be inadvertently bumped into by persons or foreign objects, possibly causing harm to the persons and/or damage to the stowable devices. This is true even though some of these stowable devices include relatively slim, rigid, ladder members with rungs. Also, moving these stowable devices between stowed and use positions may require substantial effort by a user, especially because some of these stowable devices are collapsible and/or adjustable, and it may be necessary to connect/disconnect the devices from the supporting surfaces when moving the devices between use and storage positions.

While the stowable devices in U.S. Pat. No. 4,860,854, US Published Patent Application No. 2015/0076785 and CN Published application 113147604, which include slim, rigid ladder members with rungs that slide into and out of the supporting storage rails, may be more compact, easier to move between storage and use positions and may not significantly interfere with any normal use of the support surfaces to which they are connected, the nature of the slim, rigid ladder members, including rungs which are only engaged by small portions of persons' feet, makes them less stable and less safe to use in comparison to stair units with planar steps. Also, these ladder devices are required to engage a ground surface for support when in the use positions thereof. In other words, these devices are not fully supported by the support surface to which they are attached when in the use positions thereof.

The present applicant has recently disclosed a stowable ladder device, i.e., see U.S. Pat. No. 11,794,656, which may be attached to a rub rail on a lateral side of a vehicle or trailer bed. This recently disclosed stowable ladder device is relatively easily movable between storage and use positions about a pivot member, includes a stair unit with planar steps and is readily collapsible into a compact size for storage. This stowable ladder device overcomes some of the disadvantages of the other discussed stowable ladder devices, e.g., it is stable and safe to use by any size person, and the effort required for collapsing and moving the ladder device between use and storage positions is relatively minor. However, this ladder device still intended to be connected to a rub rail on a lateral side of a vehicle or trailer bed, which may limit its suitability for use on some vehicles and trailers.

Somewhat similar to a stoawable ladder structure, there is also known a permanent stair structure by East Manufacturing that is permanently built into a flatbed trailer that may be used by an individual to walk up and down onto and off of the main platform of the semi-trailer. The permanent stir structure is located at a rear central part of the flatbed trailer including multiple steps, with the lowest step extending to approximately the rear end surface of the flatbed trailer, and further steps extending upward and inward of the trailer from the lowest step. An opening is defined in the main platform of the flatbed trailer so that the user may step directly from the topmost step onto the main platform, and a hinged cover is provided with the opening that extends flush with the main platform when the cover is closed and exposes the opening when the cover is opened. While this permanent stair structure is very sturdy and convenient to use, it requires significant and expensive permanent modifications to the flatbed trailer.

Thus, a need still exists in the art a need for a stowable, rigid stair structure configured to attached to and fully supported by a support surface, and which is robust and stable so that it may be safely used by any size person to step up onto the support surface, which may be easily moved between stored and use positions thereof, does not significantly interfere with normal use of the support surface even when disposed on a vehicle or trailer, and is also relatively lightweight and relatively inexpensive.

### SUMMARY OF THE INVENTION

Accordingly, it is an object of the present invention to provide a stowable stair structure which satisfies the discussed need.

### First Illustrative Embodiment

A stowable, rigid stair structure according to a first illustrative embodiment of the present invention comprises: a pair of support rails configured to be fixed to at least one support surface such that support rails are disposed below the at least one support surface and are spaced apart from each other; and a rigid stair unit which is movably connected to the support rails such that the rigid stair unit may be selectively moved between a stowed position beneath the at least one support surface and an operative position extending away from the at least one support surface, wherein the rigid stair unit includes at least one step and side walls connected at lateral sides of the at least one planar step, the side walls include supporting projections operatively connected to the support rails and extending in a direction away from the at least one planar step, wherein when the support rails are fixed to the at least one support surface the rigid stair unit is fully supported in both the stowed and operative positions thereof by the supporting projections operatively connected to the support rails.

Each of the supporting projections may include one or more engagement members, such as wheels, rollers or sliders, provided thereon which are spaced from each other, each of the support rails may include a channel defined therewith, the supporting projections may be operatively connected to the support rails by disposing the engagement members of the supporting projections in the channels of the support rails, and the rigid stair unit is configured to be moved between the stored and use positions thereof by movement of the engagement members along the channels. The side walls may be planar members which extend perpendicular to the at least one planar step, the side walls may be permanently fixed to the at least one planar step in a non-collapsible shape, and the supporting projections may be integral with and extend continuously from the side walls.

The at least one step of the rigid stair unit may include a fixed step having a fixed position relative to the side walls and a foldable step pivotally connected to the rigid stair unit, and which may selectively moved between an operative position extending away from the support rails and a collapsed position overlapping the fixed step.

The support rails and the rigid stair unit may be made of aluminum, other lighter weight metals or any other appropriate materials, including heavier weight metals such as steel, plastics, reinforced plastics including fiberglass or carbon fiber reinforcements, etc. The stowable, rigid stair structure may also comprise a latch mechanism which may selectively lock the rigid stair unit in at least one of the stowed and use positions thereof.

The stowable, rigid stair structure according to a first illustrative embodiment is quite advantageous over the known stowable type ladder or stair devices. For example, such stowable, rigid stair structure is relatively compact so that it may be installed and used in many different applications, including on various types of vehicles such as semi-tractor trailers, cargo vans, large commercial, agricultural and industrial vehicles, beneath surfaces of building structures, etc. Further, such stowable, rigid stair structure is easy to install and handle, e.g., it essentially consists of the support rails and the rigid stair unit. Further, the support rails may be bolted to, suspended from, welded or otherwise connected to the support surface(s) and the rigid stair unit is readily attached to the support rails by disposing the engagement members of the supporting projections in the channels of the support rails for movement therealong. Such stowable, rigid stair structure is very easy to use as it may be easily moved between its storage and use positions by rolling/moving the rigid stair unit back and forth along the support rails by the engagement members moving in the channels of the support rails, and the structure may be immediately and safely be used once the rigid stair unit is moved into its use position because the rigid stair unit is fully supported in both the stored position and the use position by the supporting projections as operatively connected to the channels of the support rails via the engagement members. Also, the planar step(s) of the rigid stair unit may provide a relatively large area for a user to easily and safely step on as the user steps up and down the rigid stair unit, and the support rails and the rigid stair unit may be made of lighter weight metals or plastics to facilitate handling and movements of the rigid stair unit.

### Modifications

According to a first modification of the stowable, rigid stair structure according to the first illustrative embodiment, the rigid stair unit may include a second foldable step pivotably connected to the rigid stair unit which may be selectively moved between an operative position extending toward the support rails and a collapsed position overlapping the rigid stair unit, wherein the first mentioned foldable step is provided at a lower portion of the rigid stair unit and pivots downward of the rigid stair unit into its operative position, and the second foldable step is provided at an upper portion of the rigid stair unit and pivots upward of the rigid stair unit into its operative position. Further, when the foldable steps are in their collapsed positions they may be disposed one above the other, with both foldable steps pivoting closely adjacent to the fixed step of the rigid stair unit. The second foldable step may be configured to closely approach or engage a side face of the at least one support surface when the second foldable step is in its operative position, thus making it easier for a user to step onto the second foldable step from the support surface. Still further, the supporting projections may extend upward of sidewalls of the rigid stair unit, the engagement members may be provided at upper portions of the supporting projections and the support rails may be disposed at positions above the side walls of the rigid stair unit, such that the side walls may be disposed beneath the support rails when the rigid stair unit is in its stowed position.

This first modification also achieves the advantages of the stowable, rigid stair structure according to the first illustrative embodiment, and is additionally advantageous because it permits the rigid stair unit to be more compact, both longitudinally and vertically, when the foldable steps are in their collapsed positions and thereby occupies less space when stowed. Also, because the second foldable step pivots upward, this may advantageously reduce the distance required for a user to initially step down from the at least one support surface onto the step for added convenience and safety, and because the second foldable step may be configured to engage a side face of the at least one support surface when the second foldable step is in its operative position, such engagement can help stabilize and lock the rigid stair unit in its operative position for enhanced safety.

A second modification of the stowable, rigid stair structure according to the first illustrative embodiment may primarily involve how the rigid stair unit, together with the supporting projections extending from the rigid stair unit, are supported. In this second modification at least one and preferably two additional engagement members, such as wheels, rollers or sliders, are provided below the rigid stair unit, and are configured to supportingly engage lower surface(s) of the rigid stair unit. The additional engagement member(s) may be attached to support surface(s) other than those to which the support rails are attached. For example, if the stowable, rigid stair structure according to the second modification is provided at a rear end of a flatbed trailer, the additional engagement member(s) may be attached to a rear bumper beam of the trailer.

In this second modification, the additional engagement member(s), along with the support rails which are operatively connected to the support rails by the engagement members provided on the supporting projections which are received in channels of the support rails, fully support the rigid stair unit in its operational and stowed positions. When the additional engagement member(s) are provided, the number of engagement members provided on the supporting projections and which are received in channels of the support rails may be reduced, e.g., instead of two engagement members on each supporting projection only one engagement member may be provided on each of the supporting projections.

This second modification also achieves the advantages of the stowable, rigid stair structure according to the first illustrative embodiment, and is additionally advantageous because it permits the rigid stair unit to be more compact when stowed and thereby the stowable stair structure may require less space to be accommodated in when it is in its stowed position.

Also, providing the additional engagement member(s) below and in engagement with the rigid stair unit facilitates installation of the rigid stair unit. For example, rear ends of the lower surfaces of the rigid stair unit may be rested on the additional engagement member(s) so that the weight of the rigid stair unit and the supporting projections is mostly supported on these additional engagement members, and then the other engagement members provided on the supporting projections may then be easily guided into the channels of the support rails as the rigid stair unit because most of the weight of the rigid stair unit is borne by the additional engagement members during this process.

A third modification to the stowable, rigid stair structure according to the first illustrative embodiment of the present invention, involves aspects of the first and second modifications, and additionally wherein the support rails and the rigid stair unit are connected together by some additional components in a rigid, compact, box-shaped arrangement that is essentially fully assembled and can be more easily and quickly attached to supporting surfaces such as being connected beneath the main platform of a tractor trailer, and wherein the rigid stair unit can also be more easily moved between storage and operative positions.

In this third modification the support rails and the rigid stair unit may be connected together by connecting members formed of metal or other appropriate materials that may be disposed outward of support rails and rigid stair unit in a generally rectangular box shape that is compact when the rigid stair unit is in its stowed position. This allows the box-shaped arrangement to be more easily connected to appropriate support surfaces via one or more of the rigid members provided at various positions of the box-shaped unit. Also, one of the connecting members may be configured to engage another supporting surface, such as a bumper beam at the rear end of tractor trailer, for additional support of the box shaped arrangement.

Latching or locking mechanisms which give extra stability to the rigid stair unit when it is in its operative and stowed positions can be provided with the box-shaped arrangement, again, for ease of operation and convenience of use. For example, in this third modification locking mechanisms for locking and supporting the rigid stair unit in its operative position may be provided on opposite sides of the rigid stair unit. Such locking mechanisms may include projecting members extending outward in a lateral direction of the box shaped arrangement and provided on opposite side walls of the rigid stair unit and mating wedges provided on one of the connecting members disposed transversely at a front, lower portion of the box-shaped arrangement. The projecting members may each include a planar metal plate or other member disposed to project at a lower, rear position of the corresponding stair unit side wall and having a lower surface angled slightly upward from rear to front, while the wedges may be provided on an upper surface of the transversely disposed connecting member at positions corresponding to the projecting members and may have upper surfaces angled slightly upward from rear to front and which receive the lower, angled surfaces of the projecting members thereon when the rigid stair unit is moved to its operative position.

With such latching or locking mechanisms, when the rigid stair unit is moved from its stowed position to its operative position, the lower surfaces of the projecting members may engage onto the slightly angled upper surfaces of the wedges in locking fashion to help maintain the rigid stair unit in its operative position. Also very advantageously, when the lower surfaces of the projecting members engage onto the wedges, much of the weight of the rigid stair unit and any load on the stair unit will be borne by the projecting members and wedges, while the loads on the engagement members which engage lower surfaces of the stair unit will be correspondingly reduced. This advantageously increases the useful lives of the engagement members. Additional, similar locking devices may be provided on opposite sides at upper portions of the box-shaped arrangement, and may jointly cooperate with the locking mechanisms at the lower portions of the arrangement to better lock and stabilize the rigid stair unit in its operative position.

In this third modification, the a stabilizing guide wheel and associated channel shaped receiver that provide stability against lateral movements of the rigid stair unit as it is moved between its stowed and operative positions may be provided at lower surfaces of box shaped arrangement. For example, the channel shaped receiver may be fixed to a lower portion rigid stair unit so as to extend in a longitudinal direction of the stair unit, while the stabilizing guide wheel may be fixed to one of the connecting members of the box shaped arrangement such that the guide wheel engages different portions of the receiver as the rigid stair unit is moved. With this disposition only guide wheel and one channel shaped receiver are required to maintain stability, noting that the wheel and receiver can be provided at a laterally central position of the box shaped arrangement, and may be used instead of the guide wheels provided on the supporting projections as in the first exemplary embodiment.

### Second Illustrative Embodiment

A stowable, rigid stair structure according to a second illustrative embodiment of the present invention comprises: a pair of support rails configured to be fixed to at least one support surface such that support rails are disposed below the at least one support surface and are spaced apart from each other; and a rigid stair unit which is movably connected to the support rails such that the rigid stair unit may be selectively moved between a stowed position beneath the at least one support surface and an operative position extending away from the at least one support surface, wherein the rigid stair unit includes at least one planar step and side walls connected at lateral sides of the at least one planar step, each of the support rails include a first rail member that is configured to be fixed in position when connected to the at least one support surface and a second rail member that is movably connected to the first rail member such that the second rail member is linearly movable relative to the first rail member, the rigid stair unit is pivotally connected to the second rail members such that the rigid stair unit may be pivoted relative to the second rail members when the rigid stair unit is in its use position, and when the support rails are fixed to the at least one support surface, the rigid stair unit is fully supported in both stored and use positions thereof by the rigid stair unit operatively connected to the support rails.

Each of the second rail members may include a plurality of engagement members, such as wheels, rollers or sliders, provided thereon which are spaced from each other, each of the first rail members may include a channel defined therewith, the second rail members may be operatively connected to the support rails by disposing the engagement members of the second rail members in the channels of the first rail members, and the rigid stair unit may be configured to be moved between the stowed and operative positions thereof by movement of the engagement members of the second rail members along the channels of the first rail members.

The side walls may be planar members which extend perpendicular to the planar steps, and the side walls may be permanently fixed to the at least one planar step in a non-collapsible shape.

The rigid stair structure may further include an elongate handle pivotably connected to one of the second rail members such that the elongate handle may be pivotally moved between a collapsed position adjacent to the one second rail member and an operative position extending away from the one second rail member, wherein the elongate handle is also pivotally connected to the rigid stair unit such that when the elongate handle is in its collapsed position it maintains the rigid stair unit in a position extending parallel to the second rail members and when the handle is in its operative position it maintains the rigid stair unit in an inclined position at an angle relative to the second rail members. When the rigid stair unit is in the inclined position at the angle relative to the second rail members, one end of the rigid stair unit may be disposed above the second rail members and an opposite end of the rigid stair unit may be disposed below the second rail members.

The support rails and the rigid stair unit of this embodiment may be made of aluminum, other lighter weight metals or any other appropriate materials, including heavier weight metals such as steel, plastics including reinforced plastics including fiberglass or carbon fiber reinforcements, etc.; and one end of the elongate handle may extend above the at least one support surface when the elongate handle is in its operative position.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is an upper side perspective view of a rigid stair unit of a stowable, rigid stair structure according to a first illustrative embodiment of the present invention.

FIG. 2 is a front perspective view of the stowable, rigid stair structure according to the first illustrative embodiment of the present invention including the rigid stair unit of FIG. 1 and a pair of support rails to which the rigid stair unit is attached, the stowable, rigid stair structure being shown attached to a rear portion of a flatbed trailer and the rigid stair unit deployed operative position.

FIG. 3 is a top, front and side perspective view of the stowable, rigid stair structure of FIG. 2, again, attached to a flatbed trailer with the rigid stair unit in its operative position, and also showing an optional handrail of the stair structure fixed to the trailer in a deployed position thereof.

FIG. 4 is a side view of the stowable, rigid stair structure in FIG. 3 with the rigid stir unit in its operative position.

FIG. 5 is a side view of the stowable, rigid stair structure similar to FIG. 4, but wherein a foldable step of the rigid stair unit is in a collapsed position thereof and the optional handle is in a stowed position thereof.

FIG. 6 is a side view of the stowable, rigid stair structure similar to FIG. 5, but wherein the rigid stair unit is in a stowed position thereof.

FIG. 7 is a top front perspective view of a first modification to the stowable, rigid stair structure according to the first illustrative embodiment of the present invention.

FIG. 8 is a side view of the first modification in FIG. 7.

FIG. 9 is a perspective view of the first modification of FIG. 7 as attached to a flatbed trailer.

FIG. 10 of a perspective view of the first modification in which two foldable steps of the rigid stair unit are disposed in their collapsed positions nested above a fixed stair of the rigid stair unit.

FIG. 11 is a side view of a second modification to the stowable, rigid stair structure according to the first illustrative embodiment of the present invention, with a rigid stair unit of the structure in a stowed position thereof.

FIG. 12 is a side view of the second modification of FIG. 11, but with the rigid stair unit in an exposed position.

FIG. 13 is a side view of the second modification of FIG. 11, but with the rigid stair unit in an operative position thereof.

FIG. 14 is a front side perspective view of a stowable, rigid stair structure according to a second illustrative embodiment of the present invention, the structure shown attached to a bed of a flatbed trailer, with a rigid stair unit thereof in its operative position.

FIG. 15 is a side view of second illustrative embodiment of FIG. 14.

FIG. 16 a front side perspective view of the structure of FIG. 14 but with a rigid stair unit of the structure in an exposed, but non-operative position parallel to support rails of the structure.

FIG. 17 is a side view of the structure of FIG. 15 but with the rigid stair unit disposed in an exposed, but non-operative position thereof, and at an angle to the support rails.

FIG. 18 is a side view of the structure of FIG. 15 but with the structure disposed in a stowed position thereof beneath the flatbed trailer bed.

FIG. 19 is a side view of a third modification to the stowable, rigid stair structure according to the first illustrative embodiment of the present invention, wherein the support rails and the rigid stair unit of the structure are connected together by some additional components in a compact box-shaped arrangement that is fully assembled and can be more easily and quickly attached to supporting surfaces such as a flatbed trailer.

FIG. 20 is a top, side perspective view of the third modification of FIG. 19, wherein the rigid stair unit is moved to its operative position protruding outward of the box-shaped arrangement.

FIG. 21 is a front side view of the third modification of FIG. 19, wherein the rigid stair unit of the structure is moved to an exposed position thereof and a locking mechanism of the structure locks the rigid stair unit in its exposed position.

FIG. 22 is a rear side perspective view of the third modification of FIG. 19, wherein the rigid stair unit of the structure is moved to its exposed position.

FIG. 23 is a front side perspective view of a variation of the third modification in a stowed position thereof.

FIG. 24 is a front side perspective view of another variation of the third modification in FIG. 19, but wherein the rigid stair unit of the structure is in an operative position thereof.

### DETAILED DESCRIPTION

It should be understood that only structures and methodology needed for illustrating selected embodiments of the present invention are described herein. Other conventional structures, and those of ancillary and auxiliary components of the system, will be known and understood by those skilled in the art.

### Present Exemplary Embodiments

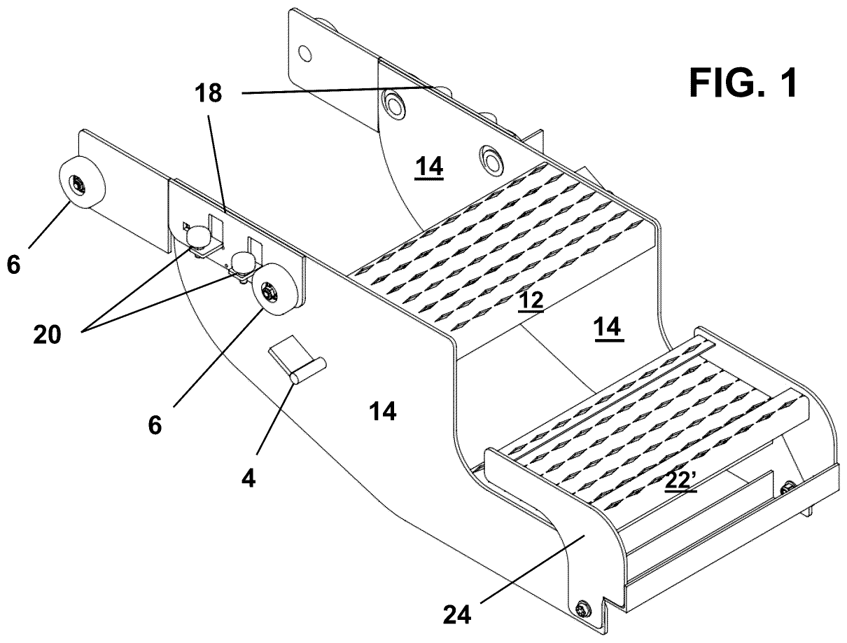

Referring to FIGS. 1-6, there is shown a stowable, rigid stair structure 1 according to an illustrative embodiment of the present invention, the structure is shown attached to support surface(s), which are surface(s) of a flatbed trailer 100, and the structure 1 is specifically shown disposed below a rear central portion of the trailer bed, at a level between the bed and a rear horizontal bumper beam 102 typically provided on flatbed trailers.

As depicted, the stowable, rigid stair structure 1 may primarily include a pair of support rails 2 that may be fixed to lower surface(s) of the trailer bed in any appropriate manner, e.g., by being bolted thereto, suspended therefrom, welded thereto, etc., and a rigid stair unit 4 that may be operatively connected to the support rails 2 using engagement members 6 such as rollers, wheels or sliders provided on lateral sides of the stair unit 4 that can be disposed in channels 8 defined in the support rails for movement along the rail channels as the rigid stair unit is moved between stowed and use positions thereof. As depicted the support rails are linear and the rigid stair unit 4 may move back-and-forth only along a linear direction, e.g., horizontally, as it is moved between its stowed and use positions. According to an important aspect of the invention, the rigid stair unit 4 may be fully supported by the support rails 2 so that a user is not required to lift the rigid stair unit 4 for moving it between the positions, which is desirable for ease of use of the stair structure 1. Also, the rigid stair unit 4 may not pivot relative to the support rails, but instead may be always maintained in a given alignment relative to the support rails.

The support rails 2 and the rigid stair unit 4 may be made of aluminum, other lighter weight metals, plastics including fiberglass reinforced plastics or other appropriate materials. Of course, the support rails 2 and rigid stair unit 4 may be made of other heavier materials, e.g., steel or stainless steel, but these would add significant weight to the stair structure 1 and may make it less easy to handle, install and use.

The support rails 2 may be linear members having a substantially “E” shaped cross section, and which may be fixed to the support surface(s) such as the bed of the flatbed trailer 100 such that the rails are disposed substantially horizontally, in parallel spaced relation to each other by a width substantially corresponding to a lateral width of the rigid stair unit 4 that is disposed therebetween. Each support rail 2 may have a first channel 8 and a second channel 10 defined therein which extend along the longitudinal length of the rail, with the channel 8 being disposed above the channel 10. The channel 8 is configured to receive the engagement members 6 therein, while the channel 10 is configured to receive guide rollers 20 therein as discussed further herein.

The rigid stair unit 4 may include one or more fixed steps 12 and one or more foldable steps 22, all of which steps may be spaced two dimensionally away from each other, and side walls 14 fixed at lateral sides of the steps. Each of the fixed steps 12 may have a top planar portion which extends substantially horizontally in parallel to the support rails 2 when the structure is attached to support surface(s), and front and/or rear edges that much are smaller than and extend perpendicularly downward from the top planar portions. With such structure, the fixed step(s) 12 provide enhanced strength, rigidity and safety compared to narrow rungs and the like typically provided on ladders. The top planar portions of the fixed step(s) may have sufficient area to easily accommodate both feet of a person, e.g., 20-30 cm×40-60 cm. The side walls 4 may be planar members which extend vertically and perpendicular to the top planar portions of the fixed step(s) 12, and the side walls may be permanently fixed to the fixed steps 12 in a non-collapsible shape in any appropriate manner, e.g., by being welded, riveted or bolted thereto. While the rigid stair unit 4 in the exemplary embodiment has two fixed steps 12, it could have one fixed step or more than two fixed steps.

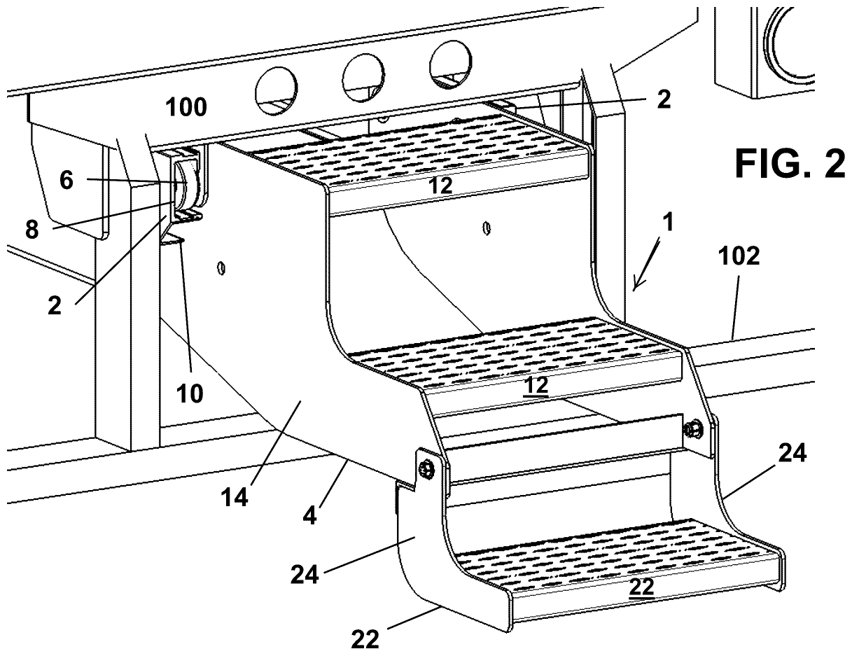

The foldable step(s) 22 may be pivotally attached to end portions of the rigid stair unit 4 with appropriate spacing relative to the fixed step(s) 12 of the rigid stair unit when the foldable step(s) are disposed in operative positions thereof. The foldable step(s) 22 add size to the rigid stair unit 4 in its operative position but need not add any significant size to the unit 4 when the foldable step(s) are in collapsed positions thereof. As depicted, a single foldable step 22 may be pivotally connected to the sidewalls 14 of the rigid stair unit 4 forwardly of and below a lowermost one of the fixed steps 12, such that the foldable step may be pivotally moved between an collapsed position (see FIGS. 1, 5, 6) and an operative position (see FIGS. 2-4). The foldable step 22 may have a structure similar to, but smaller than the rigid stair unit 4. The foldable step 22 may include a step 22′ and side walls 24 fixed at lateral sides of the step 22′. The step 22′ may have a size and shape corresponding to the fixed steps 12. In the collapsed position of the foldable step 22 it may be nested together above an upper surface of the lowermost fixed step 12 of the rigid stair unit 4 such that the foldable step 22 adds little or no size to the rigid stir unit 4 when it is in its collapsed position.

The rigid stair unit 4 with the foldable step 22 may be any desired size, but for example, may about 0.5-0.8 meter wide×1-2 meters long and 1-2 meters in height when the foldable step 22 is in its operative position, and may be about 0.5-0.8 meter wide×0.5-1.0 meters long and 0.3 to 0.5 meters in height when the foldable step 22 is in its collapsed position. With such size and construction the stowable stair structure 1 may be sufficiently robust and stable so that it may be safely used by any size person, but is still relatively compact when in its collapsed position for being stowed.

Supporting projections 18 may be provided to extend continuously from the side walls 14 of the rigid stair unit 4, extending in a direction away from the steps 12, 22. The supporting projections may be formed integrally with the side walls 14 of the rigid stair unit and extend continuously therefrom as depicted, but could be formed independently and attached to the rigid stair unit.

Referring to FIG. 2, each of the supporting projections 18 may have one or more engagement members 6 such as wheels provided thereon through which the supporting projections and are operatively connected to the support rails 2. For example, a pair of the engagement members 6 may be provided with each supporting projection 18, and may be spaced from each other along the associated supporting projection 18, e.g., near opposite ends of the supporting projection. The engagement members 6 may be other than the wheels provided they can easily move along the support rails, e.g., they may be rollers, sliders, etc. If the engagement members 6 are wheels, they may rotate about horizontal axes and may be sized to fit in the first channels 8 of the support rails 2 such that they can easily roll back-and-forth along the channels 8, while maintaining the supporting projections 18 in parallel alignment to the support rails for smooth operation. Also, a stopper (not shown) may be provided with one or both of the support rails 2 which can engage one or more of the engagement members 6 or another part of the supporting projections to prevent the supporting projections 18 from unintentionally disconnecting away from the support rails 2. While two of the engagement members 6 are provided on each of the supporting projections 18 in the depicted embodiment, it will be understood that one engagement member or more than two engagement members may be provided on each of the supporting projections.

Each of the supporting projections 18 may also have one or more guide rollers 20 provided thereon, e.g., between and at a lower level than the engagement members 6 as shown. The guide rollers 20 may rotate about vertical axes and may be sized to fit in the second channels 10 of the support rails 2. The guide rollers 20 are helpful to stably guide movements of the rigid stair unit 4 and the supporting projections 18 as he rigid stir unit is moved between the stowed and operative positions thereof. The guide rollers 20 in the second channels 10 are more helpful in handling torque loads imposed by the rigid stair unit 4, while the engagement members 6 in the first channels 8 are more helpful in handling top loads imposed by the rigid stair unit 4.

According to an important aspect of the present invention, the supporting projections 18, as operatively connected to the support rails 2 that are fixed to the support surface(s) and the rigid stair unit 4, may fully support the rigid stair unit 4, as well as the weight of a person and/or other load(s) disposed on the rigid stair unit 4, when the rigid stair unit 4 is in its stowed and use positions. Thus, when the rigid stair unit 4 is disposed in its operative position, the rigid stair unit 4 need not contact a ground surface or an additional portion of the flatbed trailer 100 for support. Rather, the rigid stair unit 4 may be spaced apart from the ground surface and surfaces of the trailer 100, and may be fully supported by the support rails 2 as fixed to the support surface(s). Of course, the rigid stair unit 4 may be constructed to engage against a ground surface or additional surface(s) of the trailer 100 for additional support, if desired.

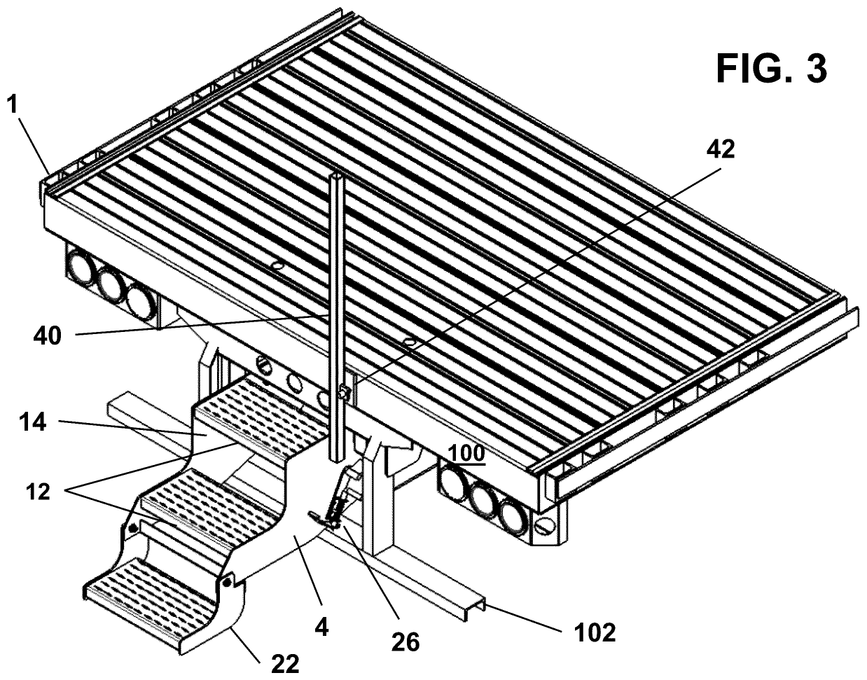

The stowable, rigid stair structure 1 may also comprise one or more devices for locking the rigid stair unit 4 in its stowed and/or use positions. Referring to FIGS. 3-6 there is shown a first latch mechanism 26 attached to one of the side walls 14 of the rigid stair unit 4 which can selectively lock the rigid stair unit in its operative position or unlock the rigid stair unit so that it may be moved between the stowed and operative positions thereof. The first latch mechanism 26 may be attached to a portion of the side wall 14 at a position generally, vertically aligned with the fixed step 12 of the rigid stair unit 4 closest to the support rails 2 in the operative position of the rigid stair unit. The first latch mechanism 26 may include a flat member 28 pivotally connected to the side wall 14, a rod member 30, a bracket 32 which connects the rod member to the flat member 28, and a guide 34 which is arc shaped having a radius which substantially corresponds to movement of the rod member 30 as attached to the flat member 28 as it pivots. The guide 34 includes multiple spaced openings defined therethrough, and through which an end of the rod member 30 may be extended when the first latch mechanism 26 is moved to latch the rigid stair unit 4 in its operative position. The rod member 30 may have a biasing member such as a spring provide therewith for urging the rod member to remain at its latched and unlatched positions, which biasing member may be disposed around the rod member and contained between a pair of projections provided with the bracket 32. The flat member 28 may have a projection 36 provided at one end thereof which engages against a surface 3 of the support rail 2 when the rod member 30 is moved to its latched position. The surface 3 may extend at a diagonal angle at the end of the support rail and may also function as the stopper which prevents the engagement members 6 from moving out of the channel 8 in the support rail. Also a simple pivoting, linear member (not shown) may be attached to the rigid stair unit which may be pivoted a first position thereof in which it engages the trailer bumper beam 102 or other surface to maintain the rigid stair unit in its stowed position, and pivoted to a second position thereof to allow the rigid stair unit to be moved relative to the support rails 2.

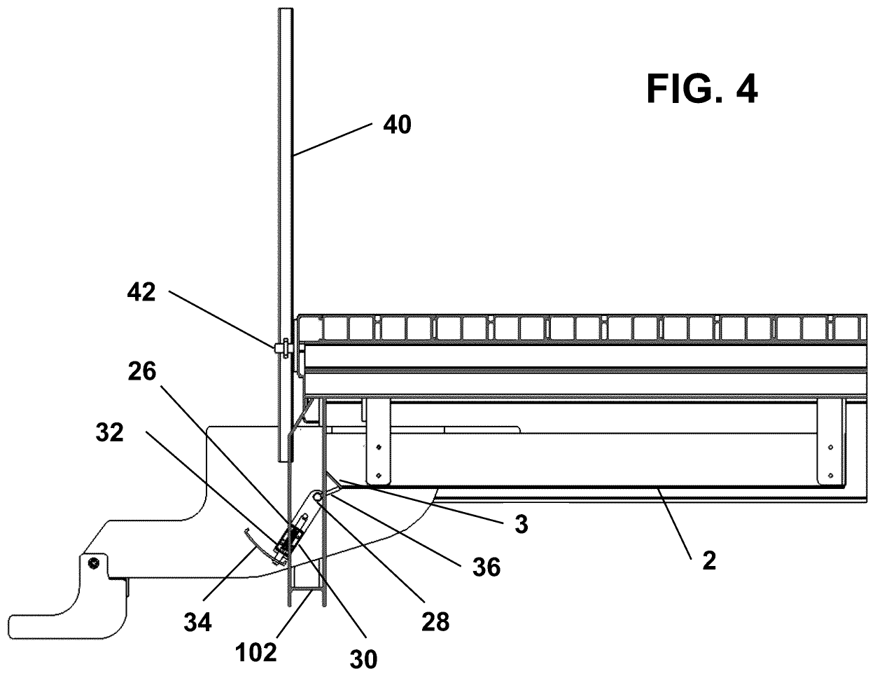

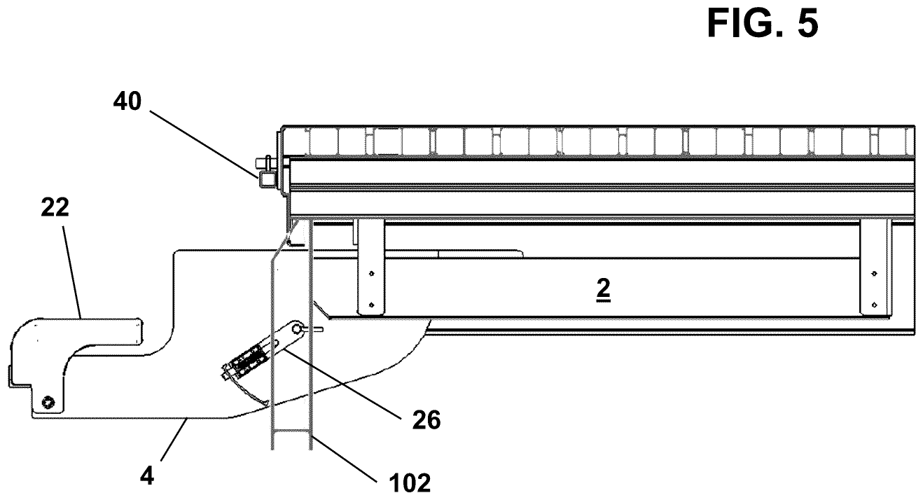

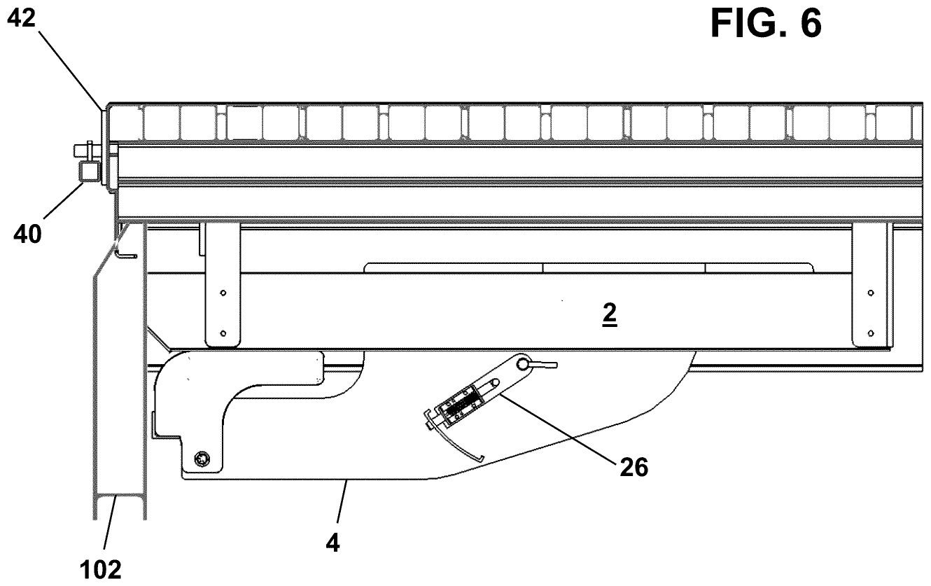

The stowable, rigid stair structure 1 is sufficiently robust and stable that it may be safely used without a handrail, but a handrail may be provided in conjunction with the stair structure 1. A handrail 40 according to an exemplary embodiment of the present invention is shown in a vertical use position thereof in FIGS. 3-4 and in a stowed horizontal position thereof in FIGS. 5-6. The handrail 40 may be linear tube with any desired cross sectional shape, e.g., round or polygonal, and may be secured to a support surface on the flatbed trailer 100 by a bracket 42. The bracket 42 may include a first member that is secured to a supporting surface such as an end surface of a flatbed trailer 100 as shown, e.g., by welding, bolting, etc., and a second member that is adjustably secured to the first member so that the handrail 40 may be securely clamped between the first and second members when desired. The handrail 40 may be otherwise provided in association with the stair structure 1 in any appropriate manner, e.g., provided in a support secured to one of the support rails 2 or to the sidewall 14 of the rigid stair unit 4.

The stowable, rigid stair structure 1 according to a first illustrative embodiment is quite advantageous over the known stowable type ladder or stair devices. For example, it is relatively easy to install and handle, e.g., the support rails may be bolted to, suspended from or welded to a support surface, the entire structure may include the support rails and the rigid stair unit operatively connected together using the engagement members 6 provided on the side walls of the stair unit which are disposed in the channels of the support rails for movement therealong, and the support rails and the rigid stair unit may be made of lighter weight metals or plastics. Further, such stowable, rigid stair structure is very easy to use as it may be easily moved between its storage and use positions by simply moving the rigid stair unit 4 back and forth between its stowed and operative positions along the support rails by engagement of the engagement members 6 in the channels of the support rails. The structure 1 may be immediately and safely be used once the rigid stair unit is move into its operative position because the rigid stair unit 4 is fully supported in both its stowed and operative positions by the supporting projections as operatively connected to the support rails which are fixed to the support surface(s), and without relying on a ground surface or additional surface for additional support.

After being installed on the support surface(s), use of the stowable, rigid stair structure 1 may simply involve unlatching the rigid stair unit 4 from its stowed position, pulling the unit out from under the support surface(s) as the engagement members 6 roll along the linear support rails 2, unfolding the foldable stair 22 and latching the rigid stair unit 4 into its operative position. These actions can be readily performed by the average person in a few seconds.

Further, the stowable stair unit 1 may be relatively lightweight when made from appropriate materials as discussed herein, it is also relatively compact and inconspicuous when in the stowed position thereof, and yet is sufficiently robust, sturdy and stable when in its operative position so that it may be used by a person even without the handrail 40. In its stowed position, the rigid stair unit 4 is disposed closely adjacent the support rails 2 beneath the support surface(s) so that it does not likely to be contacted by any foreign objects or by persons walking next to the support surface(s) to which the support rails 2 are attached.

### Modifications

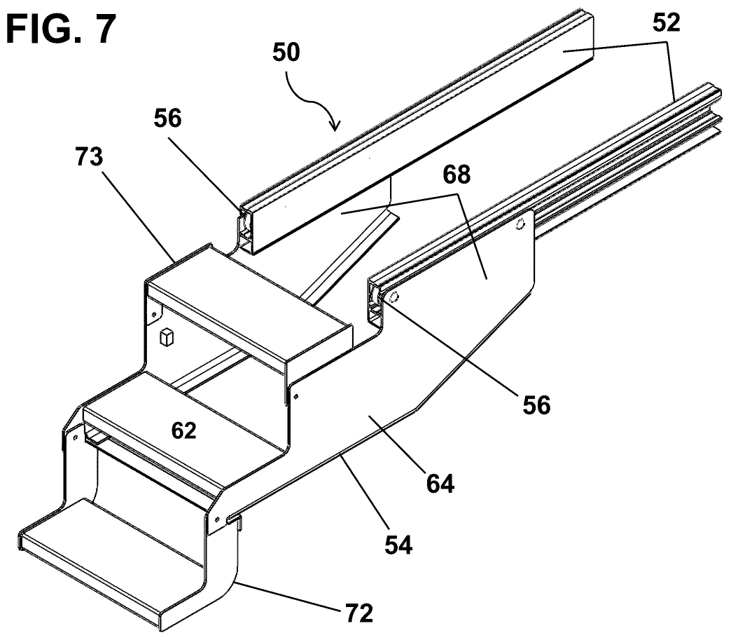

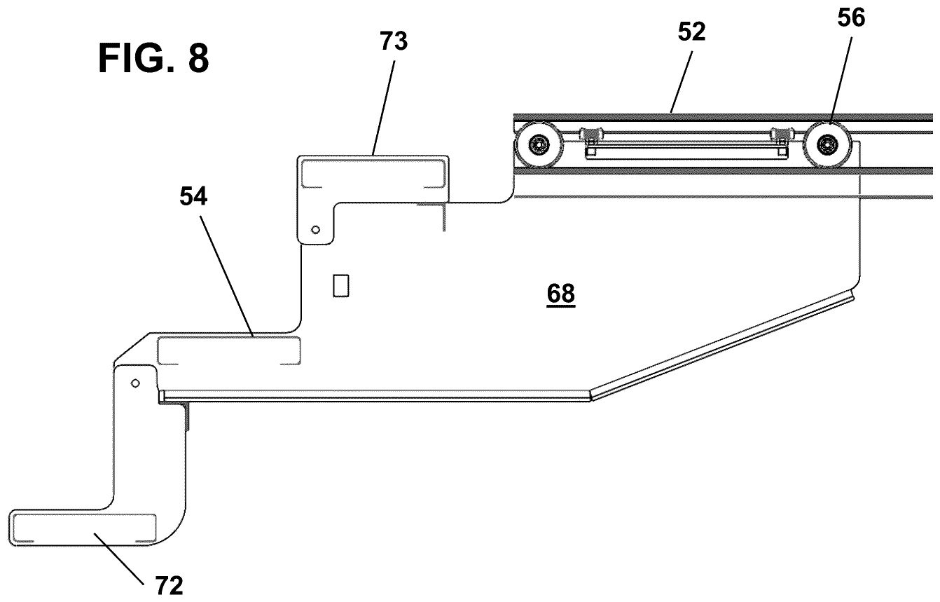

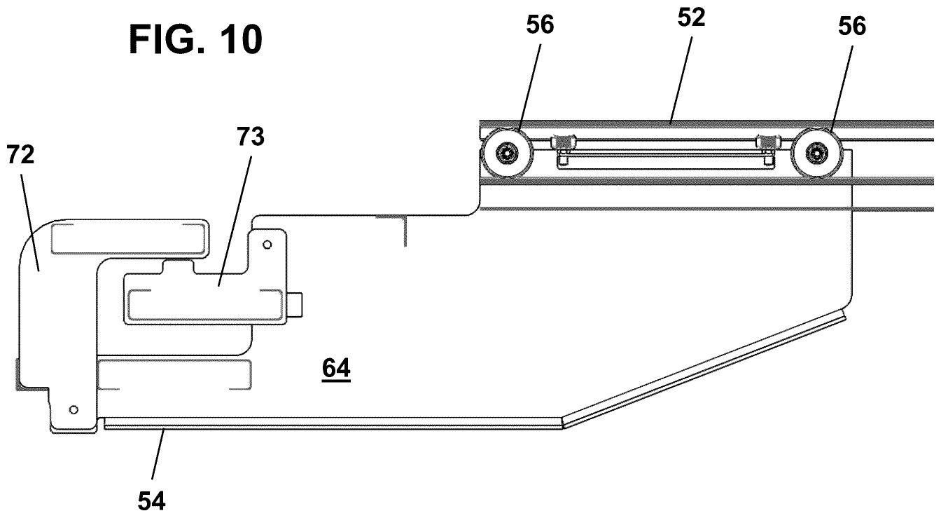

First Modification Referring to FIGS. 7-10 there is shown a stowable, rigid stair structure 50 which is a first modification of the rigid stair structure 1 according to the first illustrative embodiment. This first modification mostly includes changes to a rigid stair unit 54 in comparison the rigid stair unit 4 of the first embodiment. However, in this first modification the support rails 52 may be disposed laterally inward of the rigid stair unit 54, rather than laterally outward as with the support rails 2 and the rigid stair unit 4 in the first embodiment.

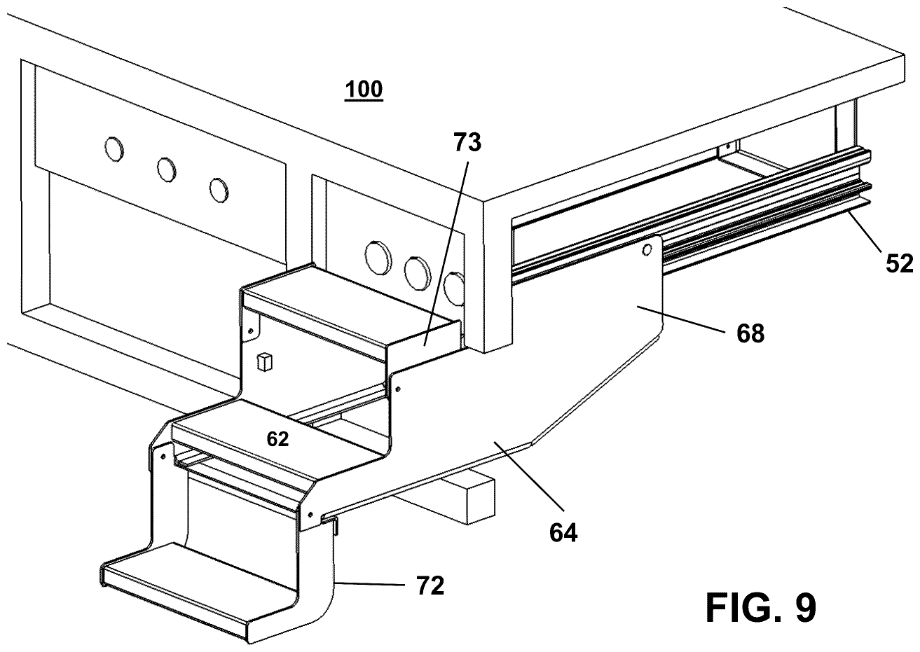

As shown, the rigid stair unit 54 in the modification may include only one fixed step 62 rigidly fixed to side walls 64, but may also include two foldable steps, i.e., one foldable step 72 pivotally connected to a lower portion of the rigid stair unit 54 and a second foldable step 73 pivotably connected to an upper portion of the rigid stair unit 54. The second foldable step 73 may pivot upward of the rigid stair unit 54 into its operative position and may pivot downward into a collapsed position disposed above the fixed step 62. The one foldable step 72 may pivot downward of the rigid stair unit into its operative position and pivot upward into its collapsed position disposed above the fixed step 62 of the rigid stair unit. As depicted, the second foldable step 73 may be folded directly adjacent to the fixed step 62 and the one foldable step 72 may be folded directly adjacent the second foldable step 73, with no portion of either of the foldable steps extending above or below the upper and lower edges of the side walls of the rigid stair unit 54, in a compact, collapsed arrangement for being stowed. Further, the second foldable step 73 may be configured to closely approach or engage a side face of the trailer 100 or other support surface when the second foldable step is in its operative position as shown in FIG. 9, which provides added stability for the rigid stair unit 54 when it is in its operative position. A latch such as a rotatable member (not shown) may be provided on the one foldable step 72 which can be rotated into a vertical orientation when the rigid stair unit is in its stowed position so as to extend below the stowed rigid stair unit and engage the bumper beam 102 of the trailer 100 to maintain the rigid stair unit in its stowed position when the stowable stair structure is attached to the trailer.

As in the first embodiment, in this first modification the rigid stair unit 54 also includes supporting projections 68 extending continuously rearward from the side walls 64 of the rigid stair unit 54, and the supporting projections may have engagement members 56, such as wheels, rollers or sliding members, provided thereon that are received into channels of the support rails 52 for operatively connecting the rigid stair unit 54 to the support rails 52. The supporting projections 68 may extend to a higher level than that of the sidewalls 64 of the rigid stair unit 64, and the engagement members 56 may be provided at upper portions of the supporting projections 68 while the support rails 52 may be disposed at positions above the side walls, so that the side walls 64 may be disposed beneath the support rails when the rigid stair unit 54 is in its stowed position.

This first modification achieves the advantages that are achieved by the stowable, rigid stair structure 1 according to the first illustrative embodiment. It also provides further advantages. For example, it permits the rigid stair unit 54 to be more compact, both longitudinally and vertically, when the foldable steps 72, 73 are in their collapsed positions and thereby requires less space to be accommodated in when the rigid stair unit is stowed. Also, because the second foldable step 73 pivots upward, this may advantageously reduce the distance required for a user to initially step down from the flatbed trailer 100 or other support surface onto the rigid stair unit 54 when the unit is in its operative position, and because the second foldable step 73 may engage a side face of the trailer 100 or other support surface when the second foldable step is in its operative position, such engagement can help stabilize and lock the rigid stair unit in its operative position for enhanced safety.

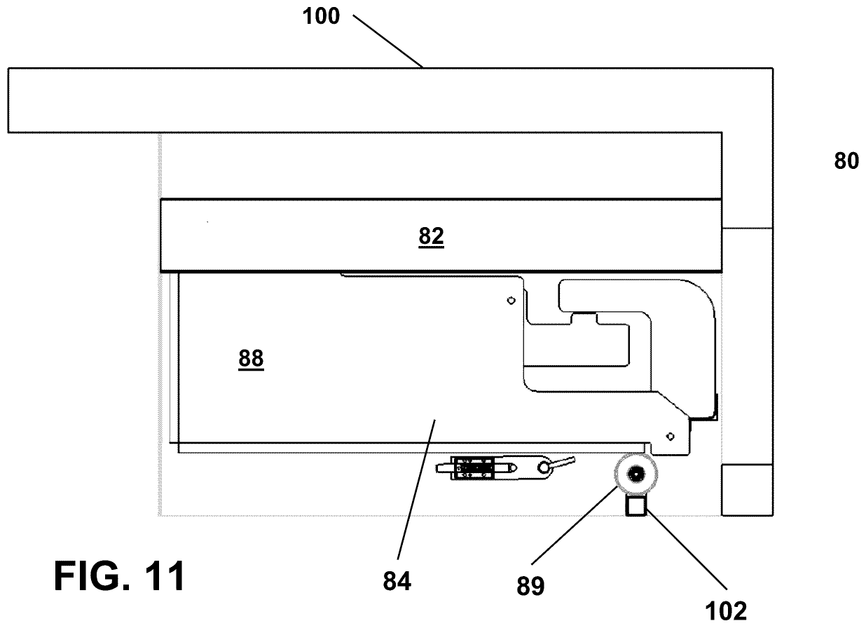

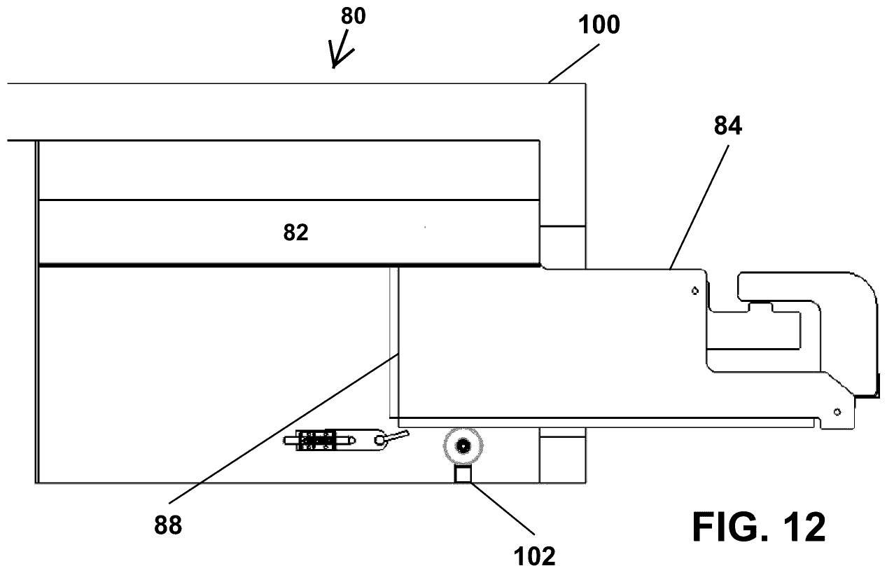

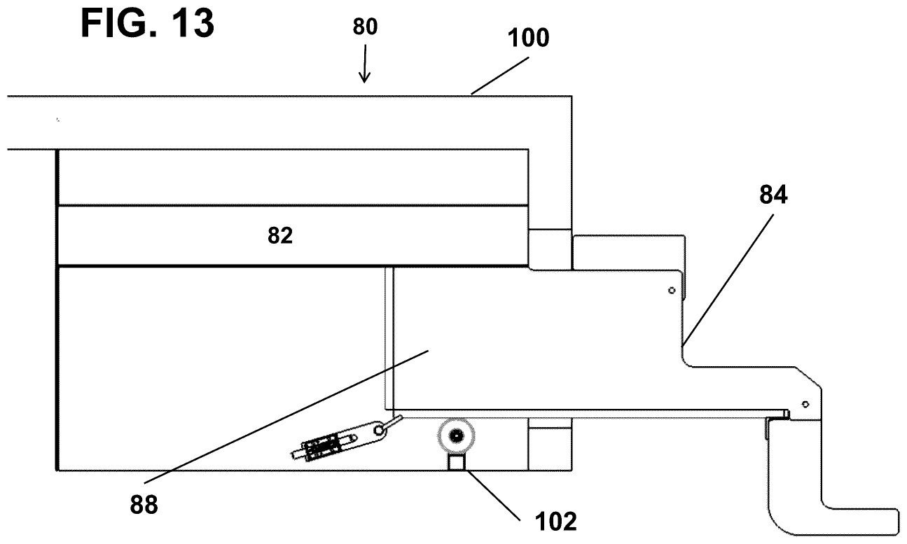

Second Modification Referring to FIGS. 11-13 there is shown a stowable, rigid stair structure 80 according to a second modification of the rigid stair structure 1 according to the first illustrative embodiment, and which may also include features according to the first modification. A primary difference according to the second modification involves how a rigid stair unit 84 of the modified structure 80, together with the supporting projections 88 extending continuously from the rigid stair unit, are supported. In this second modification at least one and preferably two additional engagement members 89, such as wheels, rollers or sliders, are provided below the rigid stair unit 84 and/or the supporting projections 88 extending from the rigid stair unit. The additional engagement member(s) 89 are configured to supportingly engage lower surface(s) of the rigid stair unit and/or the supporting projections in stowed and operational positions thereof. The additional engagement member(s) 89 may be attached to support surface(s) other than those to which the support rails 82 are attached. For example, if the stowable, rigid stair structure according to the second modification is provided at a rear end of a flatbed trailer 100, the additional engagement member(s) 89 may be attached to the bumper beam 102 of the trailer for support.

The additional engagement member(s) 89, along with the support rails 82 and the engagement members provided on the supporting projections 88 and which are received in channels of the support rails, may fully support the rigid stair unit 84 in its operational and stowed positions, as well as any load on the rigid stair unit, when the support rails are connected to support surface(s). When the additional engagement member(s) 89 are provided, the number of engagement members provided on the supporting projections 88 and which are received in channels of the support rails 82 may be reduced, e.g., instead of two engagement members being provided on each of the supporting projections 88, only one engagement member may be provided on each of the supporting projections 88.

This second modification achieves the advantages of the stowable, rigid stair structure according to the first illustrative embodiment, and is additionally advantageous because it permits the rigid stair unit to be more compact longitudinally, and thereby the stowable stair structure 80 may require less space to be accommodated in when it is in its stowed position.

Also, providing the additional engagement member(s) 89 below the rigid stair unit 84 and/or the supporting projections 88 in supporting engagement with lower surfaces of the rigid stair unit 84 and/or the supporting projections 88 facilitates installation of the rigid stair unit. For example, rear ends of the lower surfaces of the rigid stair unit 84 and/or the supporting projections 88 may be rested on the additional engagement member(s) 89 so that the weight of the rigid stair unit and the supporting projections is mostly supported on these additional engagement member(s), and then the other engagement members provided on the supporting projections 88 may then be easily guided into the channels of the support rails 82 as the rigid stair unit is moved inward in engagement with the additional engagement member(s) because much of the weight of the rigid stair unit is borne by the additional engagement member(s) 89 during this process.

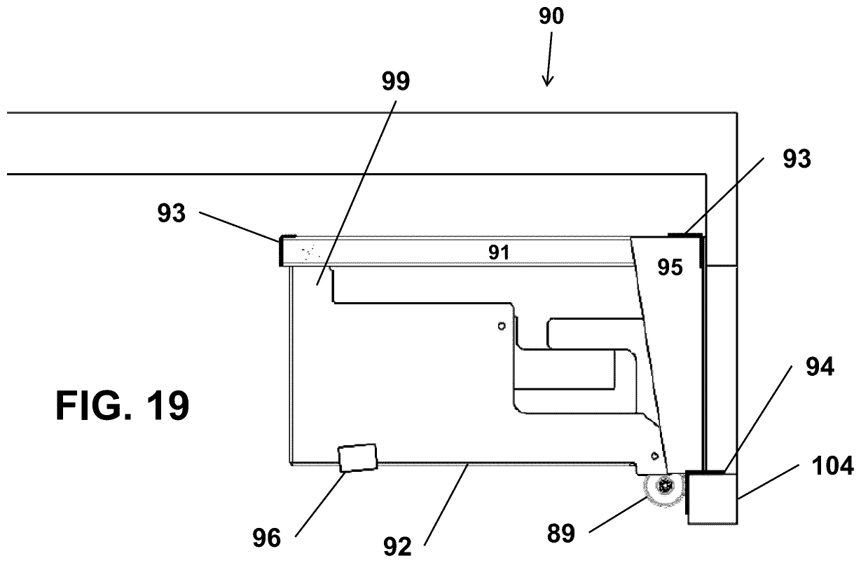

Third Modification Referring to FIGS. 19-22 there is shown a stowable, rigid stair structure 90 according to a third modification to the stowable, rigid stair structure 1 according to the first illustrative embodiment of the present invention. This third modification may include many features of the first and second modifications, but in this third modification the stowable, rigid stair structure 90 is more compact and easier to install and use because it is provided in a fully assembled, rigid, box-shaped arrangement. In the structure 90, a spaced pair of support rails 91 and a rigid stair unit 92 with supporting projections 99 extending continuously from the rigid stair unit are connected together by some additional components in the rigid, compact, box-shaped arrangement that is essentially fully assembled and can be more easily and quickly attached to supporting surfaces on a flatbed trailer or other device or location. Also, once the box-shaped arrangement is installed on desired supporting surface(s), the rigid stair unit 92 can also be more easily moved between its storage and operative positions.

As in the second modification, one or more engagement members may be provided on each of the supporting projections 99 and which are received in channels of the support rails 91, and one or more additional engagement members 89, such as wheels, rollers or sliders, may be provided at a lower position of the box-shaped arrangement and which supportingly engage lower surface(s) of the rigid stair unit 92 and/or the supporting projections 99. The additional engagement member(s) 89 may be attached to a connecting member 94 of the box-shaped arrangement also provided at a lower portion of the arrangement, as discussed further herein.

In this third modification the pair of support rails 91 are provided at upper portions of the box-shaped arrangement and the support rails may be connected together with the rigid stair unit 92 and the supporting projections extending continuously from the rigid stair unit by rigid connecting members formed of metal or other appropriate materials. When the rigid stair unit 92 is in its stowed position, the rigid connecting members may be disposed as outermost parts of the box-shaped arrangement with the rigid stair unit in a generally rectangular box shape that is compact, such as shown in FIG. 19. The connecting members may include first, transversely disposed members 93 at front and rear portions of the box shaped arrangement which connect the support rails 91 together, and the members 93 may be formed of metal bent into a right angle shape such that opposite ends of each of the members engages upper and side surfaces of the support rails. The members 93 may also enclose the ends of the support rails, and the box-shaped arrangement 90 may be connected to supporting surfaces through the connecting members 93 rather than having the support rails connected to the supporting surfaces, e.g., the box-shaped arrangement 90 may be bolted to bottom surfaces of a bed of a trailer 100 using bolts that connect to different portions of the connecting members 93.

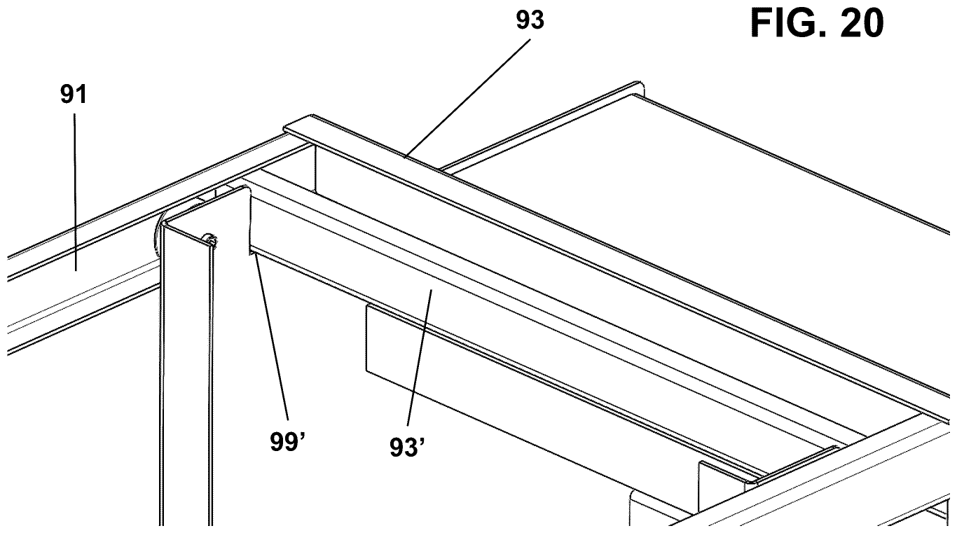

A second transversely extending connecting member 93′ may be provided beneath the front one of the connecting members 93 and which also connects front portions of the support rails 91 together, as shown in FIG. 20. The connecting member 93′ may have an I-shaped cross section, and lower surfaces of opposite ends of the member 93′ may engage in with surfaces 99′ of the supporting projections 99 extending rearward from the rigid stair unit 92 when the stair unit is in its operative position. This provides additional support and stability to the stair unit 92 in addition to the support provided by the engagement members within the support rails 91 and the engagement members 89 which engage lower surfaces of the rigid stair unit 92.

The connecting members may also include a third transversely disposed connecting member 94 which is disposed at a lower, front portion of the box-shaped arrangement and vertically extending members or gussets 95 which are connected between the support rails 91 and the second transversely disposed member 94 at the front end of the box shaped arrangement 90. If the stowable stair structure 90 is provided on a flatbed trailer 100, the third transversely disposed member 94 may be supported on the bumper beam 102 typically provided at the rear end of a flatbed trailer 100, and the connecting member 94 may have a right angle shape such that when the member 94 is supported on the bumper beam 102, the two portions of the right angle shape engage top and vertical side faces of the bumper beam, respectively. The connecting member 94 may be supported on the bumper beam only by gravity without being connected to the bumper beam 102 by welding or bolts, but could be connected to the bumper beam 102 by welding, bolts or the like if desired. The engagement members 89 at the lower portion of the box-shaped arrangement may be supportingly connected to the third transversely disposed member 94 using brackets or other appropriate means.

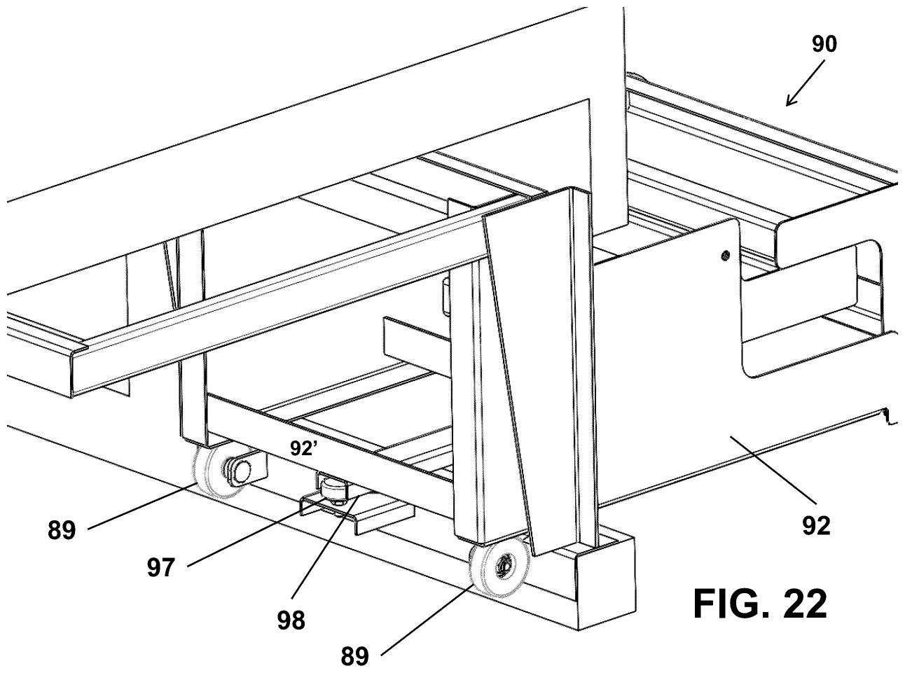

As shown in FIG. 22 the rear portion of the rigid stair unit may include lower surfaces that extend inward from the side walls of the rigid stair unit and these lower surfaces may be engaged by the additional engagement members 89, while rear ends of the side walls may be bent inward and be connected by a transversely extending connecting member 92′.

The vertically extending connecting members or gussets 95 may be mainly flat or planar in shape with a flange 95′ that extends perpendicularly to the planar portion at the front end of the box-shaped arrangement 90. The flange 95′ may also be connected to the first transversely disposed members 93 at the front portion of the box shaped arrangement. All of the connecting members 93, 93′, 94 and 95 may be formed of metal such as sheet metal which is bent or formed into appropriate shapes so that they do not add much to the overall size of the stowable stair structure 90. The metal may be stainless steel, aluminum, or other appropriate metals.

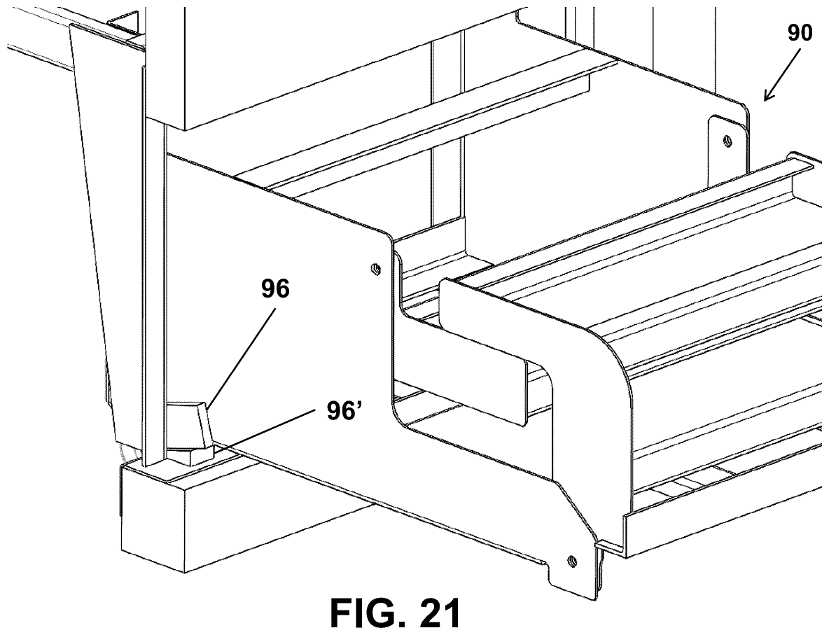

The structure 90 according to the third modification of the first embodiment may also latching or locking devices which give extra stability to the rigid stair unit 92 when it is in its operative and stowed positions can be provided. With reference to FIGS. 19 and 21, for example, in this third modification locking mechanisms may be provided on opposite sides of the rigid stair unit 92, which include projecting members 96 extending outward in a width direction of the box shaped arrangement and provided on opposite side walls of the rigid stair unit 92 and wedges 96′ provided on the third transversely disposed connecting member 94 at a front portion of the box-shaped arrangement. The projecting members 96 and wedges 96′ may be made of metal and may include respective angled surfaces which wedges are configured to be engaged together when the rigid stair unit 92 is moved into its operative position. As depicted, the projecting members 96 may each include a planar metal plate or other member disposed to project at a lower, rear position of the corresponding side wall of the rigid stair unit and may have a lower surface angled slightly upward from rear to front, while the wedges 96′ may be provided on an upper surface of the third transversely disposed connecting member 94 at positions corresponding to the projecting members 96 and may have upper surfaces angled slightly upward from rear to front and which receive the lower, angled surfaces of the projecting members 96 thereon when the rigid stair unit is moved to its operative position.

With such locking mechanisms, when the rigid stair unit 92 is moved from its stowed position to its operative position, the lower surfaces of the projecting members 96 will engage onto the slightly angled upper surfaces of the wedges 96′ in locking fashion to help maintain the rigid stair unit in its operative position. Also very advantageously, when the lower surfaces of the projecting members engage onto the surfaces of the wedges, much of the weight of the rigid stair unit and any load on the stair unit will be borne by the projecting members 96 and wedges 96′, while the loads on the engagement members 89 which engage lower surfaces of the stair unit and the engagement members on the supporting projections 99 will be correspondingly reduced. This advantageously increases the useful lives of the engagement members. Similar latching or locking mechanisms may be provided with upper portions of the rigid stair unit 92, but are not shown in the drawings. For example, two additional ones of such latching or locking mechanisms may be provided on opposite sides at upper portions of the box-shaped arrangement, and may also function when the rigid stair unit is moved into its operative position. These mechanisms may include projecting members and mating wedges having structures similar to the projecting members 96 and wedges 96′, and collectively all of the locking mechanisms may function to better lock and support the rigid stair unit in is operative position. For example, the additional locking mechanisms may include projecting members projecting laterally outward from upper portions of the rigid stair unit 92 or from the supporting projections 99, and cooperating wedges that are connected to the support rails 91 and extend beneath the support rails. As with the projecting members 96 and wedges 96′, these projecting members would lockingly engage onto the wedges when the rigid stair unit is moved to its operative position. However, orientation of these projecting members and wedges may be opposite to that of the supporting projections 96 and wedges 96′, e.g., the projecting members and mating wedges of the additional locking mechanisms may have mating slanted surfaces that are higher in the rear and lower in the front. With such opposite orientations of the locking mechanisms at the lower and upper portions of the structure 90, the rigid stair unit 92 is essentially compressed between the locking mechanisms when the stair unit is in its operative position. Of course, the additional locking mechanisms at upper portions of the structure 90 may be oriented the same as the locking mechanisms at the lower portion of the structure. Also, the wedges of the additional latching or locking mechanisms may be disposed anywhere along the support rails 92, and are not limited to being disposed toward the front of the box-shaped arrangement. These additional latching or locking mechanisms would also help to bear much of the weight of the rigid stair unit and any loads thereon, while reducing loads on the engagement members in the support rails.

With reference to FIG. 22, a stabilizing guide wheel 97 and associated channel shaped receiver 98 that provide stability against lateral movements of the rigid stair unit 92 as it is moved between its stowed and operative positions may be provided at lower surfaces of box shaped arrangement. For example, the channel shaped receiver 98 may be fixed to a lower portion rigid stair unit 92 so as to extend parallel to the longitudinal direction of the stair unit, while the stabilizing guide wheel 97 may be disposed in a fixed position and supported by third transversely disposed connecting member 94 such that the guide wheel 97 may engage different portions of the receiver 98 as the rigid stair unit 92 is moved back and forth between its stowed and operative positions. With this disposition only one guide wheel 97 and one channel shaped receiver 98 are sufficient to properly guide movements of the rigid stair unit, noting that the wheel and receiver may be provided at a laterally central position of the box shaped arrangement.

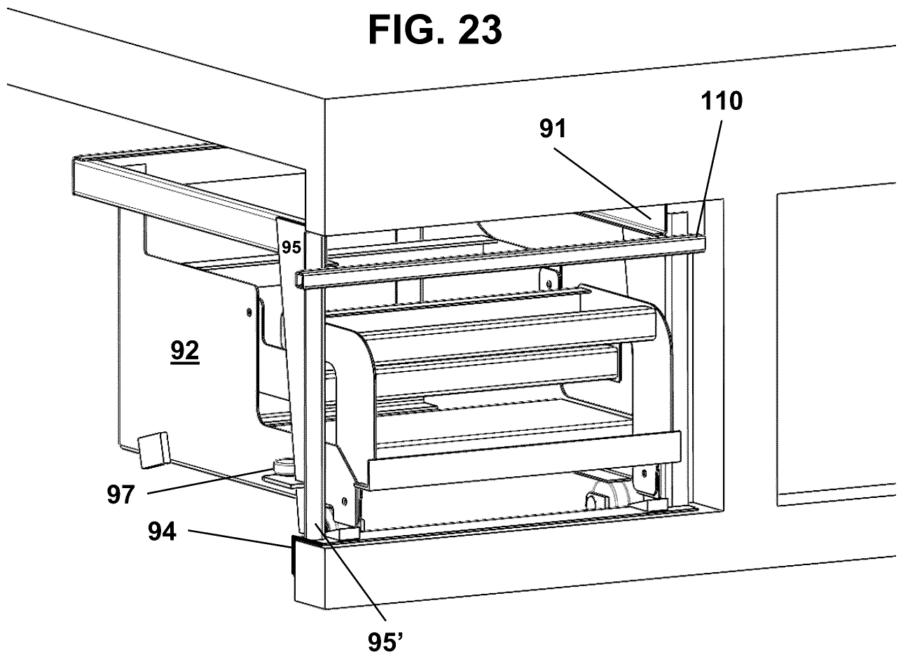

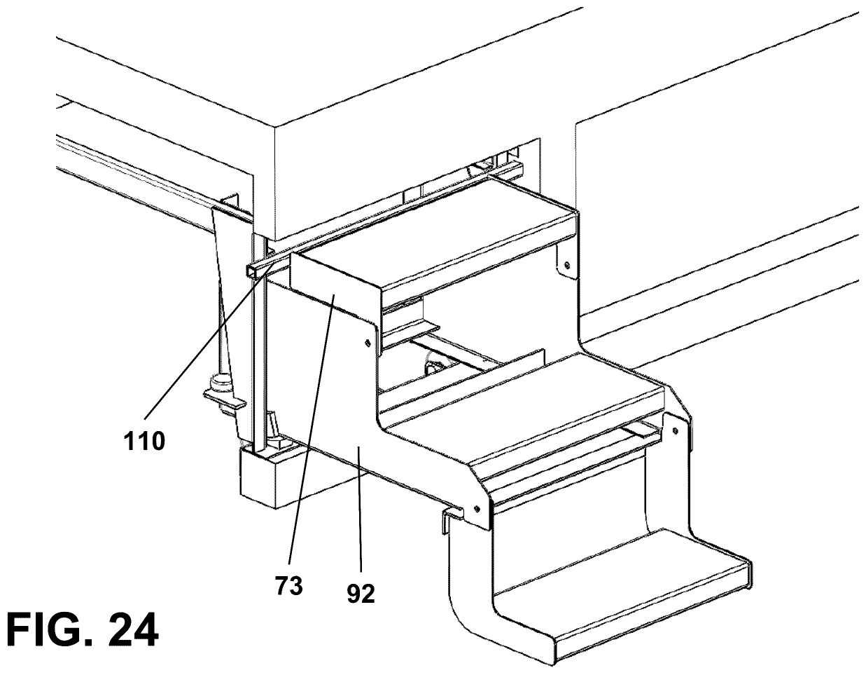

Referring to FIGS. 23 and 24 there are shown some optional variations of the structure 90 according to the third modification. According to one variation, instead of the single guide wheel 97 and associated channel shaped receiver 98 used in the structure 90 shown in FIG. 20, a pair of guide wheels 97′ may be respectively provided to project from the vertically extended gussets 95 on opposite sides of the box-shaped arrangement such that the guide wheels 97′ respectively engage the side walls of the stair unit 92 to guide movements of the stair unit. Provision of the guide wheels 97′ on the gussets is less complex and less expensive than provision of the single guide wheel 97 and the associated receiver 98. According to another variation, instead of the second transversely disposed connecting member 93′ which engages surfaces 99′ of the supporting projections 99 extending rearward from the rigid stair unit 92, a different transversely disposed connecting member 110 may be provided which interconnects the flanges 95′ of the vertically extending connecting gussets 95 at an upper position of the box-shaped arrangement, whereby the upper folding step of the rigid stair unit will engage against the transversely disposed connecting member 110 when the upper folding step is moved into its operative position as shown in FIG. 24. This variation provides added stability that resists rearward movement of the stair unit from its operative position. According to a third variation the support rails 91′ may be disposed laterally inward of the supporting projections 99 and engagement members that are received within the support rails 91 may be disposed on laterally inner surfaces of the supporting projections. This variation is more compact and opposite to the arrangement shown in FIG. 19 wherein the support rails 91 are disposed laterally outward of the supporting projections 99 and engagement members are disposed on outer surfaces of the supporting projections 99. This third variation is similar to the arrangement in the first modification shown in FIGS. 7-10.

Again, the box-shaped arrangement according to the third modification and the variations of the third modification is essentially fully assembled such that it can be more easily handled and quickly attached to supporting surfaces at a rear end of a tractor trailer 100 or other device or location. Also, once the box shaped arrangement is installed the rigid stair unit can also be more easily moved between storage and operative positions.

### Second Illustrative Embodiment

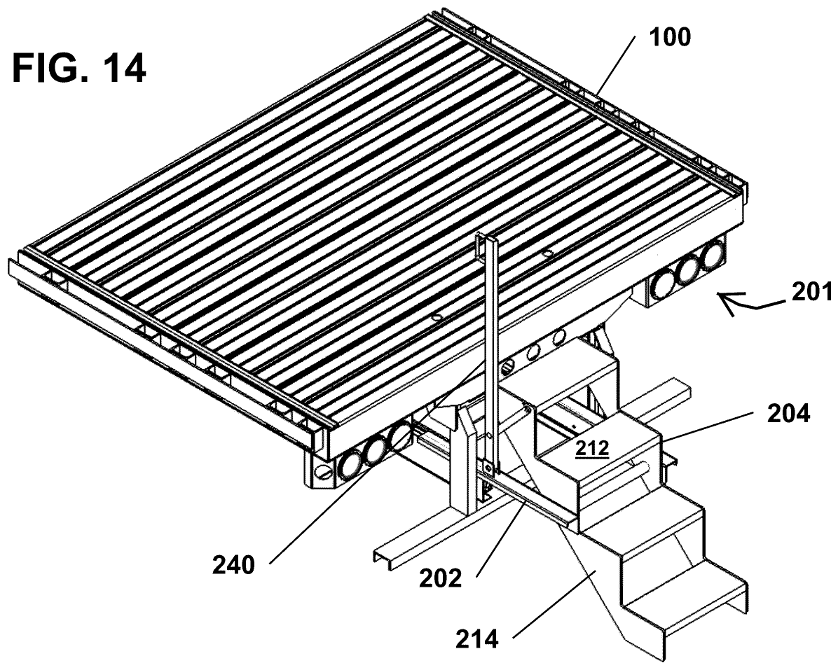

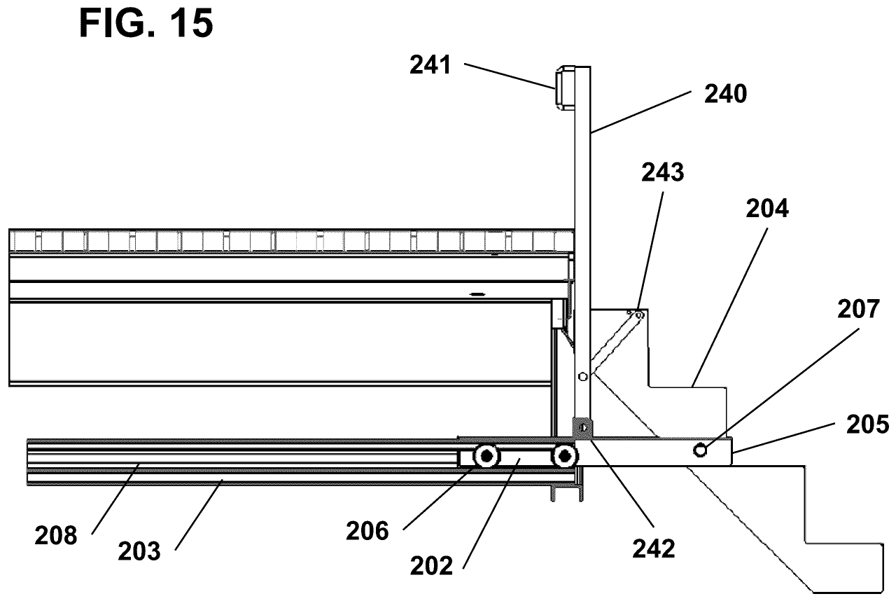

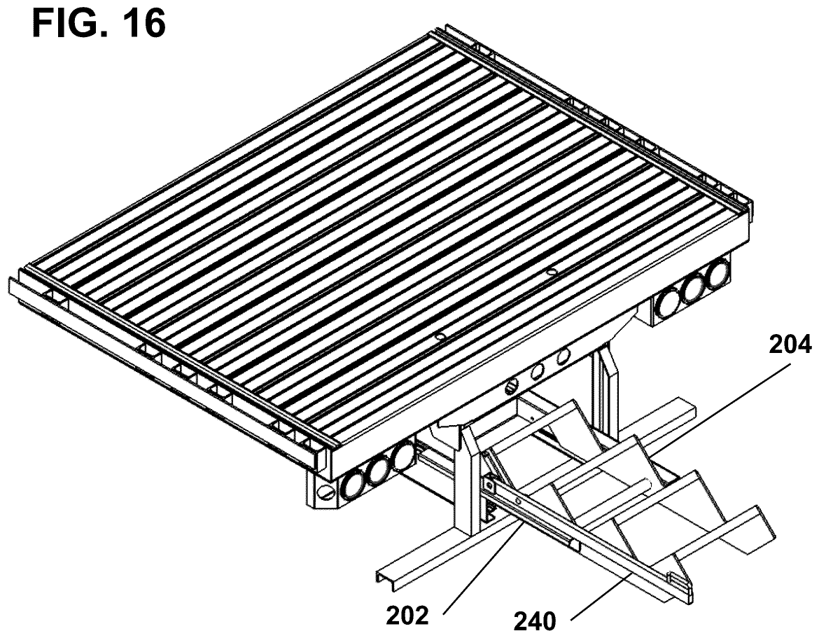

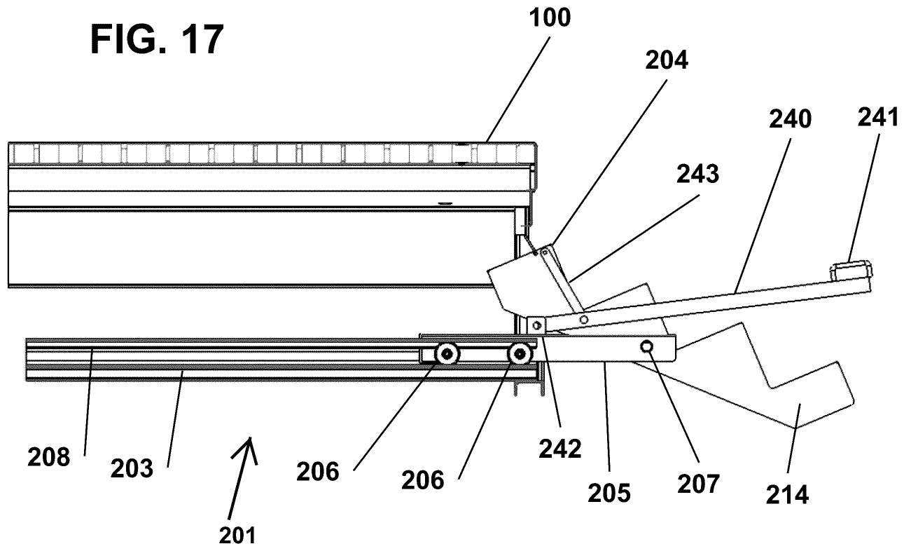

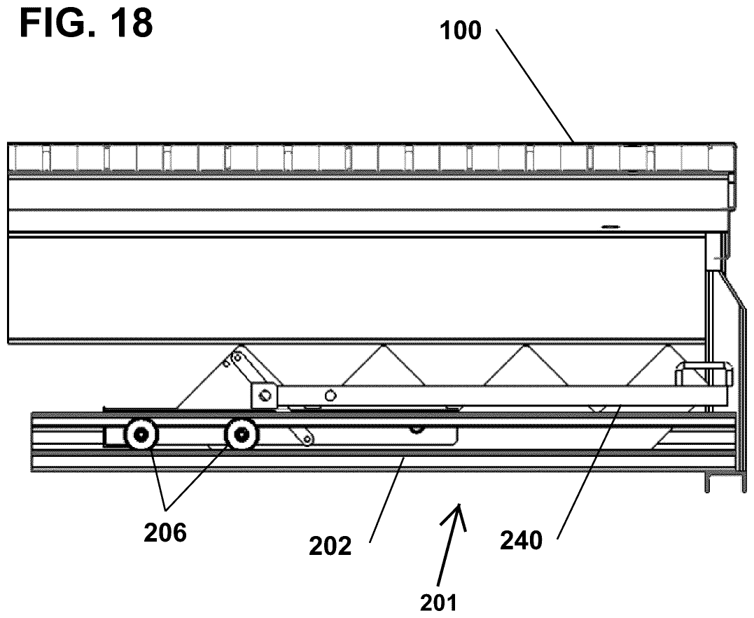

Referring to FIGS. 14 to 18 there is shown a stowable, rigid stair structure 201 according to a second illustrative embodiment of the present invention, the structure is shown attached to a bed of a flatbed trailer 100, with FIG. 18 showing the stair structure in its stowed position, FIGS. 16 and 17 showing the structure with the rigid stair unit 204 moved out to an exposed position not beneath the trailer bed, and FIGS. 14 and 15 showing the rigid stair unit 204 in its operative position.

The stowable, rigid stair structure 201 according to a second illustrative embodiment of the present invention generally comprises: a pair of the support rails 202 which may be configured to be fixed to at least one support surface such that support rails are disposed below the at least one support surface and are spaced apart from each other, and the rigid stair unit 204 which is movably connected to the support rails such that the rigid stair unit may be selectively moved between a stowed position beneath the at least one support surface and exposed and operative positions extending away from the at least one support surface. As in the first embodiment, the support rails and the rigid stair unit may be made of aluminum, other lighter weight metals or any other appropriate materials, including heavier weight metals such as steel, plastics including reinforced plastics including fiberglass or carbon fiber reinforcements, etc.

Referring to FIGS. 15, 17 and 18, each of the support rails 202 include a first rail member 203 that is configured to be fixed to the at least one support surface in a set, fixed position and a second rail member 205 that is movably connected to the first rail member 203 and also pivotally connected to the rigid stair unit 204. When the second rail members are moved relative to the first rail members, the rigid stair unit as connected to the second rail members is correspondingly moved between a stowed position beneath the at least one support surface and an exposed position not beneath the at least one support surface. Once in its exposed position, the rigid stair unit 204 can then be pivoted relative to the second rail members 204 to be placed in an operative position of the rigid stair unit as discussed further herein. When the rigid stair unit 204 is in its inclined position at the angle relative to the second rail members, one end of the rigid stair unit may be disposed at a higher level relative to the at least one support surface of the flatbed trailer than the level of the one end when the rigid stair unit is in its stowed position.

The first rail members 203 may have a structure similar to that of the support rails 2 of the first exemplary embodiment, including a channel 208 for accommodating engagement members therein, while each of the second rail members 205 may include a plurality of engagement members 206, such as wheels, rollers or sliders, provided thereon which may be spaced longitudinally from each other along the second rail member and configured to be received in the channels 208 of the first rail members 203 for operatively connecting the second rail members 205 to the first rail members 203 and for facilitating movements of the second rail members relative to the first rail members.

The rigid stair unit 204 may include multiple fixed steps 212, which may be spaced two dimensionally away from each other, and side walls 214 fixed at lateral sides of the steps. The rigid stair unit 204 may be formed of the same materials as discussed for use in forming the rigid stair unit 4 of the first exemplary embodiment. Each of the steps 212 may have top planar portions which extend substantially horizontally in parallel to the support rails 202 when the rigid stair unit is in its operative use position, and front and/or rear edges that much are smaller than and extend perpendicularly downward from the top planar portions. The steps 212 may have dimensions such as those of the step(s) 12 in the first exemplary embodiment. The side walls 214 may be planar members which extend vertically and perpendicular to the top planar portions of the steps 212, and the side walls may be permanently fixed to the planar steps 212 in a non-collapsible shape in any appropriate manner, e.g., by being welded, riveted or bolted thereto. Although the depicted rigid stair unit 204 does not include any foldable steps, one or more foldable steps could be provided with the stair unit.

The rigid stair unit 204 in the second exemplary embodiment may be longer and include more fixed steps 212 in comparison to the rigid stair unit 4 of the first exemplary embodiment based on the structure of the support rails 202 and how the rigid stair unit 204 is connected to the support rails as discussed herein. For example, the rigid stair unit 204 may have four fixed steps 212 as depicted, but it could have fewer or more than four fixed steps, as well as one or more foldable steps.

The rigid stair unit 204 may be connected to the second rail members 205 through pivot members 207 such that the rigid stair unit 204 may be pivoted relative to the second rail members 205 through the pivot members when the rigid stair unit and second rail members are moved out from under the support surface(s) to which the support rails 202 are connected so as to move the rigid stair unit into its operative position. The pivot members 207 may be connected between longitudinally intermediate portions of the second rail members 205 and longitudinally intermediate portions of the rigid stair unit 204, noting that such positioning of the pivot members provides desirable support balance of the rigid stair unit 204 relative to the support rails 202 and particularly relative to the second rail members 205. Also, because an intermediate portion of the rigid stair unit is its pivot point, when one end of the rigid stair unit further away from the support surface such as the trailer 100 is pivoted downward, the other end of the rigid stair unit is pivoted upward, so that the rigid stair unit extends at an angle to horizontal from top to bottom which is stable and convenient for persons using the stair structure 201.

To facilitate movement of the rigid stair unit 204 relative to the second rail members 205 and increase stability of the stowable stair structure 201 in its operative use position, a handle 240 may be provided which is pivotally connected to one of the second rail members 205. As depicted the handle 240 may be an elongate tubular member having a free end with a handle grip 241 which a user may grip when manipulating the handle, and an opposite end pivotally connected to the second rail member 205, e.g., through a pivot bracket 242 fixed to the second rail member, or in any other appropriate manner. As depicted, the handle 240 can be pivoted between a compact storage position adjacent and parallel to the second rail member 205 to which it is connected (see FIGS. 16 and 18) and an operative use position extending perpendicular to the second rail member (see FIGS. 14 and 15). Further, the handle 240 may also be operatively connected to the rigid stair unit 204 through a pivoting link 243 that connects a portion of the handle to a side wall 214 of the rigid stair unit. The link 243 effectively acts as a second connection between the rigid stair unit 204 and the second rail member 205, whereby an operator's movement of the handle 240 from its storage position to its operative position can also help pivot and lock the rigid stair unit into its operative position extending at an angle to the second rail member, and an operator's movement of the handle to its storage position can also help pivot the rigid stair unit into its position parallel to the second rail member.

The handle 240 with the link 243 are desirable for multiple reasons, e.g., a person using the stair structure can grip the free end of the handle while ascending and descending the stair structure 201 for additional safety and stability, the handle provides leveraged force for more easily moving the rigid stair unit 204 between its positions, the handle effectively holds or locks the rigid stair unit in its stowed and operative use positions for greater safety, the handle occupies minimal space for storage, etc.

As with the first exemplary embodiment, when the support rails 202 are fixed to the at least one support surface the rigid stair unit 204 may be fully supported in both stored and use positions thereof by the rigid stair unit operatively connected to the support rails, and the stair structure need not be operatively connected to any other support member or surface. Of course the rigid stair unit 204 could be connected and/or engaged to another support surface or member when in its operative position for enhanced rigidity and safety, e.g., the lowest most step of the rigid stair unit 204 could be configured to rest on the ground when in its operative use position, a latch member could be provided for connecting a portion of the rigid stair unit to a support surface or member when in the operative use position, etc.

Although the present invention has been described herein with respect to a number of specific illustrative embodiments, the foregoing description is intended to illustrate, rather than to limit the invention. Those skilled in the art will realize that many modifications of the illustrative embodiment could be made which would be operable. For example, in the third modification of the first exemplary embodiment of the stowable, rigid stair structure discussed herein, the transversely extending connecting member 94 need not be engaged to or supported on any other member such as the bumper beam 104 of a flatbed trailer 100.

Also, the features of the different, exemplary embodiments, modified embodiments and variations of the present invention disclosed herein may be used in others of the embodiments and modified embodiments if so desired. All such modifications, which are within the scope of the claims, are intended to be within the scope and spirit of the present invention.

I claim:

1. A stowable, rigid stair structure comprising:
a pair of support rails configured to be fixed to at least one support surface such that the support rails are disposed below the at least one support surface and are spaced apart from each other;
a rigid stair unit including at least one step and side walls connected at lateral sides of the at least one step; and
supporting projections extending continuously from the side walls of the rigid stair unit in a direction away from the at least one step and operatively, movably connected to the support rails to permit the rigid stair unit to be moved relative to the support rails between stowed and operative positions of the rigid stair unit, wherein
when the support rails are fixed to the at least one support surface, the rigid stair unit is fully supported in both the stowed and use positions thereof by the supporting projections operatively connected to the support rails and by the at least one support surface.

2. The stowable, rigid stair structure according to claim 1, wherein each of the supporting projections includes an engagement member provided thereon, each of the support rails includes a channel defined therewith which receives the engagement member provided on a corresponding one of the supporting projections, and the engagement members move along the channels of the support rails when the rigid stair unit is moved relative to the support rails.

3. The stowable, rigid stair structure according to claim 1, wherein the side walls are planar members which extend vertically, and the side walls are fixed to the at least one step.

4. The stowable, rigid stair structure according to claim 1, wherein the support rails are linear.

5. The stowable, rigid stair structure according to claim 1, wherein the supporting projections are formed integrally with the side walls of the rigid stair unit, respectively.

6. The stowable, rigid stair structure according to claim 1, further comprising at least one guide wheel which engages surfaces of the rigid stair unit or surfaces of one of the support rails to maintain alignment of the rigid stair unit as it is moved relative to the support rails.

7. The stowable, rigid stair structure according to claim 1, wherein the at least one step of the rigid stair unit includes a fixed step which is non-movably connected to the side walls and at least one foldable step that is movable relative to the side walls between collapsed and operative positions of the at least one foldable step.

8. The stowable, rigid stair structure according to claim 7, wherein the at least one foldable step includes a first foldable step that folds downward into its operative position and a second foldable step that folds upward into its operative position, wherein the first and second foldable steps are disposed adjacent to each other and to the fixed step in a vertical alignment when the first and second foldable steps are in stowed positions thereof.

9. A stowable, rigid stair structure comprising:
a pair of support rails configured to be fixed to at least one support surface such that the support rails are disposed below the at least one support surface and are spaced apart from each other;
a rigid stair unit including at least one step and side walls connected at lateral sides of the at least one step;
supporting projections extending continuously from the side walls of the rigid stair unit in a direction away from the at least one step and operatively, movably connected to the support rails to permit the rigid stair unit to be moved relative to the support rails between stowed and operative positions of the rigid stair unit; and
at least one engagement member which engages and supports a lower surface of the rigid stair unit,
wherein when the support rails are fixed to the at least one support surface, the rigid stair unit is fully supported in both the stowed and use positions thereof by the supporting projections operatively connected to the support rails, the at least one engagement member which engages and supports a lower surface of the rigid stair unit, and by the at least one support surface.

10. The stowable, rigid stair structure according to claim 9, further comprising connecting members which connect the support rails, the supporting projections and the rigid stair unit in a box-shaped arrangement when the rigid stair unit is in its stowed position, wherein the box-shaped arrangement is configured to be attached as an assembled unit to the at least one support surface.

11. The stowable, rigid stair structure according to claim 10, wherein the connecting members include a first transverse connecting member connecting the support rails together at an upper portion of the box-shaped arrangement, a second transverse connecting member extending beneath the rigid stair unit at a front portion of the box-shaped arrangement, and gussets which connect the support rails to the second transverse connecting member.

12. The stowable, rigid stair structure according to claim 11, wherein the second transverse connecting member is configured to engage another support surface disposed beneath the box-shaped arrangement.

13. The stowable, rigid stair structure according to claim 10, wherein the connecting members include a transverse connecting member at front portion of the box-shaped arrangement and the supporting projections extending continuously from the side walls of the rigid stair unit include upper surfaces which engage against the transverse connecting member for stability when the rigid stair unit is in its operative position.

14. The stowable, rigid stair structure according to claim 10, wherein the connecting members include a transverse connecting member at front portion of the box-shaped arrangement and the at least one step of the rigid stair unit includes a foldable step which pivots upward relative to the side walls of the rigid stair unit to an operative position of the foldable step, and the foldable step engages against the transverse connecting member for stability when the foldable step is in its operative position.

15. The stowable, rigid stair structure according to claim 10, wherein the connecting members include a transverse connecting member at front portion of the box-shaped arrangement, and the stowable, rigid stair structure further comprises a locking mechanism which locks the rigid stair unit in its operative position, the locking mechanism includes a projecting member which projects laterally outward from a sidewall of the rigid stair unit and a wedge provided on the transverse connecting member, wherein when the rigid stair unit is moved into its operative position the projecting member slides onto the wedge while slightly raising the rigid stair unit relative to the support rails.

16. A stowable, rigid stair structure comprising:
a pair of support rails configured to be fixed to at least one support surface such that the support rails are disposed below the at least one support surface and are spaced apart from each other; and
a rigid stair unit including at least one step and side walls connected at lateral sides of the at least one step, wherein
each of the support rails includes a first rail member which remains in a set position once the support rail is fixed to the at least one support surface and a second rail member which is movable relative to the first member,
the rigid stair unit is pivotally connected to the second rails members such that the rigid stair unit moves together with the second rail members relative to the first rail members, and the rigid stair unit can be pivoted relative to the second rail members, and
when the support rails are fixed to the at least one support surface, the rigid stair unit is fully supported by the support rails and by the at least one support surface.

17. The stowable, rigid stair structure according to claim 16, wherein the rigid stair unit is pivotally connected to the second rails members at longitudinally intermediate positions of the rigid stair unit, the rigid stair unit includes two steps which are spaced from each other in a longitudinal direction of the rigid stir unit such that when the rigid stair unit is pivoted at an angle relative to the second rail members one of the two steps is above a position where the rigid stair unit pivotally connects to the second rail members and the other of the two steps is below the position where the rigid stair unit pivotally connects to the second rail members.

18. The stowable, rigid stair structure according to claim 16, further including a handle which is pivotally connected to one of the second rail members, and the handle is pivotable relative to the one second rail member between a stowed position extending parallel to the one second rail member and an operative position extending perpendicular to the one second rail member.

19. The stowable, rigid stair structure according to claim 18, wherein the handle member is also connected to the rigid stair unit through a pivotable link such that movement of the handle also pivots the rigid stair unit relative to the one second rail member, and the handle is in its operative position it locks the rigid stair unit in a set position.
